(19) United States
(12) Patent Application Publication
(10) Pub. No.: US 2024/0228843 A1
(43) Pub. Date: Jul. 11, 2024

(54) PRESSURE SENSITIVE ADHESIVE COMPOSITION AND PRESSURE SENSITIVE ADHESIVE SHEET

(71) Applicants: ARTIENCE CO., LTD., Chuo-ku, Tokyo (JP); TOYOCHEM CO., LTD., Chuo-ku, Tokyo (JP)

(72) Inventor: Tomoki SHIMOMURA, Chuo-ku, Tokyo (JP)

(73) Assignees: ARTIENCE CO., LTD., Chuo-ku, Tokyo (JP); TOYOCHEM CO., LTD., Chuo-ku, Tokyo (JP)

(21) Appl. No.: 18/685,624

(22) PCT Filed: Sep. 12, 2022
(86) PCT No.: PCT/JP2022/034044

§ 371 Date: Feb. 22, 2024

(30) Foreign Application Priority Data
Sep. 15, 2021 (JP) 2021-150215
Mar. 15, 2022 (JP) 2022-039823

(51) Int. Cl. C09J 133/08; C08K 5/092; C09J 7/38; C09J 11/06; C09J 133/06

(52) U.S. Cl. CPC C09J 133/08; C08K 5/092; C09J 7/38; C09J 11/06; C09J 133/064; C09J 2301/302; C09J 2301/40; C09J 2433/00

(57) ABSTRACT

A pressure sensitive adhesive composition and a pressure sensitive adhesive sheet which can be made ageless, and have not only sufficient pressure sensitive adhesive properties but also excellent storage stability and can be used stably for a long period even after a curing agent is blended are provided. A pressure sensitive adhesive composition according to a first aspect includes an acrylic polymer (A), a metal chelate compound (B), and a polycarboxylic acid compound (C). The acrylic polymer (A) is a copolymer of a monomer mixture including a monomer (a1) having an acidic group, and a content of the monomer (a1) having the acidic group is 0.01 mass % or more and 20 mass % or less per 100 mass % of the monomer mixture.

### TECHNICAL FIELD

This disclosure relates to a pressure sensitive adhesive composition and a pressure sensitive adhesive sheet.

### BACKGROUND

Since a pressure sensitive adhesive sheet having a pressure sensitive adhesive layer formed from a pressure sensitive adhesive is easier to handle than an adhesive, it is used in a wide range of fields as a label for display and a tape for fixing. There are various resin-based pressure sensitive adhesives, with acrylic pressure sensitive adhesives being widely used, especially. The acrylic pressure sensitive adhesives have an advantage that the basic pressure sensitive adhesive performance such as pressure sensitive adhesion force and tack can be easily controlled by adjusting a monomer composition and compatible additives. The acrylic pressure sensitive adhesive is usually blended with a curing agent to be applied to produce a pressure sensitive adhesive sheet. However, a problem has been the need for an aging period to allow the reaction between an acrylic resin and the curing agent to achieve a sufficient cohesive force or processability.

Japanese Unexamined Patent Application Publication No. 2019-172748 discloses a pressure sensitive adhesive composition as an acrylic pressure sensitive adhesive, including an ethylene unsaturated group-containing acrylic resin (A) with an ethylene unsaturated group-containing structural site obtained through a hemiacetalization reaction in a side chain of an acrylic resin, and a photopolymerization initiator (B).

International Patent Publication No. WO 2013/002489 also discloses a pressure sensitive adhesive composition including an acrylic copolymer having a functional group crosslinkable with an isocyanate, a toluene diisocyanate crosslinker, and an organic acid stabilizer. Japanese Unexamined Patent Application Publication No. 2012-031250 discloses a pressure sensitive adhesive composition including a carboxyl group-containing acrylate polymer, an aluminum chelate compound, and a citric acid monoester.

International Patent Publication No. WO 98/03208 discloses a pressure sensitive adhesive composition containing a carboxyl group-containing acrylate polymer, aluminum acetylacetonate, and adipic acid or octanedioic acid.

Japanese Unexamined Patent Application Publication No. 2019-19239 discloses a pressure sensitive adhesive composition for a protective film including a (meth)acrylic resin having at least a carboxy group and a metal chelate crosslinking agent. Japanese Unexamined Patent Application Publication No. 2017-132862 discloses a pressure sensitive adhesive composition for a protective film including a (meth)acrylic polymer having an acid value of 9 mg KOH/g or more and 70 mg KOH/g or less, a metal chelate crosslinking agent having 0.3 mg or more and 2.0 mg or less equivalent of an acid value per 1 equivalent of an acidic group of the (meth)acrylic polymer, and an antistatic agent.

Japanese Unexamined Patent Application Publication No. 2021-161357 discloses a pressure sensitive adhesive composition including a (meth)acrylic triblock polymer having a block structure represented by A-B-A composed of specific types of blocks A and B and having Mw in a specific range, a (meth)acrylic polymer having a structural unit derived from a (meth)acrylic acid alkyl ester and having Mw in a specific range, and an tackifier.

### SUMMARY

The pressure sensitive adhesive composition of Patent Literature 1 needs a facility for emitting an active energy beam in order to cure, and only drying in a hot air oven commonly used for acrylic pressure sensitive adhesives does not achieve a desired effect, posing a problem of limited versatility.

In addition, the pressure sensitive adhesive composition of Patent Literature 2 is susceptible to the influence of water and humidity, and due to the pot life of about 24 hours after blending a curing agent, it is difficult to achieve a one-part formulation of the curing agent and the pressure sensitive adhesive. In the market, there is a demand for a pressure sensitive adhesive composition excellent in versatility and storage stability.

The present disclosure has been made in view of the above circumstances and an object thereof is to provide a pressure sensitive adhesive composition and a pressure sensitive adhesive sheet which can be made ageless and have not only sufficient pressure sensitive adhesive properties but also excellent storage stability and can be used stably for a long period even after a curing agent is blended.

The present inventor has identified solutions to the issues disclosed herein and have successfully completed this disclosure in the following aspects.

[1]: A pressure sensitive adhesive composition comprising:
an acrylic polymer (A);
a metal chelate compound (B); and
a polycarboxylic acid compound (C), wherein
the acrylic polymer (A) is a copolymer of a monomer mixture including a monomer (a1) having an acidic group,
a content of the monomer (a1) having the acidic group is 0.01 mass % or more and 20 mass % or less per 100 mass % of the monomer mixture;
the polycarboxylic acid compound (C) is at least one kind of a dicarboxylic acid compound selected from a group consisting of malonic acid, succinic acid, maleic acid, fumaric acid, itaconic acid, citraconic acid, mesaconic acid, phthalic acid, and cis, trans-1,2-cyclohexanedicarboxylic acid, and
a content of the polycarboxylic acid compound (C) is 0.10 to 2.0 parts by mass per 100 parts by mass of the acrylic polymer (A).

[2]: The pressure sensitive adhesive composition according to claim 1, wherein at least one of pKa values of the polycarboxylic acid compound (C) in water is in the range of 1.0 to 3.5.

[3]: A pressure sensitive adhesive composition comprising:
an acrylic polymer (A);
a metal chelate compound (B); and
a polycarboxylic acid compound (C), wherein
the acrylic polymer (A) is a copolymer of a monomer mixture including a monomer (a1) having an acidic group,
a content of the monomer (a1) having the acidic group is 0.01 mass % or more and 20 mass % or less per 100 mass % of the monomer mixture;
the polycarboxylic acid compound (C) includes at least one kind selected from a group consisting of saturated dicarboxylic acids, unsaturated dicarboxylic acids, aromatic-containing polycarboxylic acids, and aliphatic cyclic structure-containing polycarboxylic acids,
a content of the polycarboxylic acid compound (C) is 0.010 parts by mass or more and 9.0 parts by mass or less per 100 parts by mass of the acrylic polymer (A), and
a value of a gel fraction rate (P) of toluene and ethyl acetate represented by Expression (21) is 0.2 or more.

(P)=(Gel fraction rate (Y) when toluene is used as an extraction solution)/(gel fraction rate (X) when ethyl acetate is used as an extraction solution) (21)

[4]: The pressure sensitive adhesive composition according to claim 3, wherein the gel fraction rate (X) when ethyl acetate is used as the extraction solution is 10% or more and 95% or less.

[5]: The pressure sensitive adhesive composition according to [3] or [4], wherein the value of the gel fraction rate (P) of toluene and ethyl acetate is 0.3 or more and 0.98 or less.

[6]: A pressure sensitive adhesive sheet comprising:
a substrate; and
a pressure sensitive adhesive layer formed from the pressure sensitive adhesive composition according to any one of [1] to [5].

According to the present disclosure, it is possible to achieve a pressure sensitive adhesive composition and a pressure sensitive adhesive sheet which can be made ageless and have not only sufficient pressure sensitive adhesive properties but also excellent storage stability and can be used stably for a long period even after a curing agent is blended.

### DETAILED DESCRIPTION OF EMBODIMENTS

The details of the present disclosure will be described below. In this specification, the terms “(meth)acrylic acid” and “(meth)acrylate” indicate “acrylic acid or methacrylic acid” and “acrylate or methacrylate”, respectively, unless otherwise explained. The term “(meth)acrylic ester monomer” refers to a generic term of “acrylic ester monomer” and “methacrylic ester monomer”.

A monomer (a1) with an acidic group, a (meth)acrylic acid alkyl ester monomer (a2), a (meth)acrylic acid alkyl ester monomer (a2x) with an alkyl group of 1 to 3 carbon atoms, a (meth)acrylic acid alkyl ester monomer (a2y) with an alkyl group of 4 to 12 carbon atoms, and a (meth)acrylic acid alkyl ester monomer (a2z) with an alkyl group of 13 carbon atoms or more may be referred to as a monomer (a1), a monomer (a2), a monomer (a2x), a monomer (a2y), and a monomer (a2z), respectively.

As used in the present specification, “Mw” is the weight-average molecular weight in polystyrene equivalent obtained by gel permeation chromatography (GPC) measurement. “Mn” is the number-average molecular weight in polystyrene equivalent obtained by the GPC measurement. They can be measured by the method described in the section of [Example].

Unless otherwise noted, various components mentioned in this specification can be used independently, either individually or in combination with two or more.

### First Embodiment

### <<Pressure Sensitive Adhesive Composition>>

A pressure sensitive adhesive composition according to a first embodiment includes an acrylic polymer (A), a metal chelate compound (B), and a polycarboxylic acid compound (C), in which the acrylic polymer (A) is a copolymer of a monomer mixture having a monomer (a1) including an acidic group, and the content of the monomer (a1) including an acidic group is 0.01 mass % or more and 20 mass % or less in 100 mass % of a monomer mixture.

According to the first embodiment, it is possible to provide a pressure sensitive adhesive composition which has a high degree of crosslinking in a short time, can be made ageless, and has not only sufficient pressure sensitive adhesive properties but also excellent storage stability and can be used stably for a long period even after a curing agent is blended. That is, according to the pressure sensitive adhesive composition of the first embodiment, the high degree of crosslinking in a short time enables the pressure sensitive adhesive composition to be ageless only by volatilizing a solvent in, for example, a hot air oven without the need for irradiation with active energy rays. Furthermore, it is possible to provide a pressure sensitive adhesive and a pressure sensitive adhesive sheet which not only have sufficient pressure sensitive adhesive properties, are not affected by moisture, have excellent storage stability, and can be used stably for a long time even after a curing agent is blended.

### <Acrylic Polymer (A)>

Acrylic polymer refers to a polymer of a monomer having an ethylenically unsaturated bond such as a (meth)acrylic acid ester monomer. Acrylic polymer (A) is a copolymer of a monomer mixture including at least a monomer (a1) having an acidic group, and the content of the monomer (a1) having an acidic group is 0.01 mass % or more and 20 mass % or less in 100 mass % of the monomer mixture.

The monomers are classified into a monomer (a1) having an acidic group, a (meth)acrylic acid alkyl ester monomer (a2), and other monomers excluding the monomers (a1) and (a2). As the monomer constituting the acrylic polymer (A), the monomer (a1) is preferably used as an essential component, and further the monomer (a2) is preferably used, and other monomers may be used as necessary.

[Monomer (a1)]

The monomer (a1) is a monomer having an acidic group. By using the monomer (a1), a polymer network is formed by a cross-linking reaction with a reactive functional group of the metal chelate 25 compound (B) described later, and thus a cohesive force of the acrylic polymer (A) can be enhanced.

Examples of the monomer (a1) include carboxylic acid having unsaturated bonds such as (meth)acrylic acid, 2-carboxyethyl(meth)acrylate, 2-(meth)acryloyloxyethyl-succinic acid, 2-(meth)acryloyloxyethyl hexahydrophthalic acid, 2-(meth)acryloyloxyethyl-phthalic acid, 2-(meth)acryloyloxyethyl acid phosphate, crotonic acid, maleic acid, itaconic acid, fumaric acid, citraconic acid, and mesaconic acid. Among these compounds, (meth)acrylic acid and 2-carboxyethyl(meth)acrylate are preferable in terms of cohesion strength of the resulting pressure sensitive adhesive composition, reactivity of the metal chelate compound (B), and copolymerization compatibility with other monomers.

The content of the monomer (a1) is 0.01 mass % or more and 20 mass % or less, preferably 0.1 mass % or more and 18 mass % or less, more preferably 0.9 mass % or more and 15 mass % or less, and even more preferably 2 mass % or more and 12 mass % or less in 100 mass % of the monomer mixture constituting the acrylic polymer (A).

When the content of the monomer (a1) is 0.01 mass % or more, it is possible to form a crosslink with the metal chelate compound (B) and develop a practical cohesive force. When the content of the monomer (a1) is 20 mass % or less, it is possible to suppress pressure sensitive adhesion of the pressure sensitive adhesive composition to an adherend even after peeling the pressure sensitive adhesive sheet from the adherend. In addition, it is possible to exhibit a satisfactory pressure sensitive adhesive force to low-polarity members such as olefin. Furthermore, by keeping the content of the monomer (a1) to 20 mass % or less, the viscosity of the pressure sensitive adhesive composition can be suppressed, and a non-volatile content can be set within a practical range.

[Monomer (a2)]

The monomer (a2) is a (meth)acrylic acid alkyl ester monomer.

As the (meth)acrylic acid alkyl ester monomer, a (meth)acrylic acid alkyl ester monomer with an alkyl group of 1 to 12 carbon atoms is preferably used. The (meth)acrylic acid alkyl ester monomer is further classified into (meth)acrylic acid alkyl ester monomer with an alkyl group of 1 to 3 carbon atoms (a2x), (meth)acrylic acid alkyl ester monomer with an alkyl group of 4 to 12 carbon atoms (a2y), and (meth)acrylic acid alkyl ester monomer with an alkyl group of 13 or more carbon atoms (a2z). The monomer (a2) is preferably used (a2y) and more preferably (a2x) and (a2y) are used together.

The content of the monomer (a2) is preferably, but not particularly limited to, 20 mass % or more and 99.9 mass % or less, and more preferably 50 mass % to 98 mass % in 100 mass % of the monomer mixture constituting the acrylic polymer (A). By maintaining this range, it is possible to achieve a balance between high pressure sensitive adhesion and high cohesion.

The content of the monomer (a2x) is preferably, but not particularly limited to, 5 mass % or more and 85 mass % or less, more preferably 5 mass % or more and 50 mass % or less, and even more preferably 10 mass % or more and 30 mass % or less in the monomer (a2). When the content of the monomer (a2) is 5 mass % or more, a high cohesive force can be exhibited.

The content of the monomer (a2y) is preferably, but not particularly limited to, 15 mass % or more and 95 mass % or less, more preferably 15 mass % or more and 94.9 mass % or less, and even more preferably 50 mass % or more and 90 mass % or less in the monomer (a2). When the content of the monomer (a2y) is 15 mass % or more and 95 mass % or less, a high pressure sensitive adhesive force can be exhibited.

Examples of the monomer (a2x) include methyl (meth) acrylate, ethyl (meth) acrylate, propyl (meth) acrylate, and the like.

Examples of the monomer (a2y) include butyl (meth)acrylate, isobutyl (meth)acrylate, pentyl (meth)acrylate, hexyl (meth)acrylate, heptyl (meth)acrylate, 2-ethylhexyl (meth)acrylate, octyl (meth)acrylate, nonyl (meth)acrylate, isononyl (meth)acrylate, decyl (meth)acrylate, isodecyl (meth)acrylate, lauryl (meth)acrylate, and the like.

Among these compounds, butyl acrylate, (iso)butyl acrylate, and 2-hexyl acrylate are preferable, because they exhibit good pressure sensitive adhesion to various adherends.

Examples of the monomer (a2z) include tridecyl (meth)acrylate, tetradecyl (meth)acrylate, hexadecyl (meth)acrylate, heptadecyl (meth)acrylate, stearyl (meth)acrylate, isostearyl (meth)acrylate, and the like.

### [Other Monomers]

Other monomers refer to monomers other than the monomer (a1) and the monomer (a2).

As for other monomers, there are no specific limitations, and suitable monomers that can copolymerize with the monomer (a1) and the monomer (a2) can be chosen as needed. Examples of other monomers include other vinyl monomers such as vinyl acetate, vinyl propionate, styrene, acrylonitrile, and the like, monomers with aliphatic cyclic structures such as isobutyl (meth)acrylate, and cyclohexyl (meth)acrylate, monomers with aromatic rings such as phenyl (meth)acrylate, phenoxyethyl (meth)acrylate, benzyl (meth)acrylate, and biphenyl (meth)acrylate, monomers with alkoxy(poly)alkylene oxide such as 2-methoxyethyl acrylate, 2-ethoxyethyl acrylate, methoxy polyethylene glycol (meth)acrylate, methoxy polypropylene glycol (meth)acrylate, and ethoxy polypropylene glycol (meth)acrylate, monomers with hydroxyl groups, monomers with amino groups, monomers with other nitrogen atoms, monomers with epoxy groups, monomers with isocyanate groups, and the like.

Examples of monomers with hydroxyl groups include hydroxyalkyl (meth)acrylate such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate and hydroxy (meth)acrylamide such as hydroxymethylacrylamide and hydroxyethylacrylamide.

Examples of monomers with amino groups include monoalkylamino ester (meth)acrylate such as monomethylaminoethyl (meth)acrylate, monoethylaminoethyl (meth)acrylate, monomethylaminopropyl (meth)acrylate, monoethylaminopropyl (meth)acrylate, and the like.

Examples of other monomers with other nitrogen atoms include (meth)acrylamide, N-vinylpyrrolidone, acryloylmorpholine, and the like.

Examples of monomers with epoxy groups include glycidyl (meth)acrylate, methylglycidyl (meth)acrylate, 3, 4-epoxycyclohexylmethyl (meth)acrylate, 6-methyl-3, 4-epoxycyclohexylmethyl (meth)acrylate, and the like.

Examples of monomers with isocyanate groups include 2-isocyanatoethyl (meth)acrylate and the like.

### [Method for Producing Acrylic Polymer (A)]

The method for producing the acrylic polymer (A) is not particularly limited, and the acrylic polymer (A) can be obtained by polymerizing the above monomer mixture by a known radical polymerization reaction. The reaction may be carried out under solvent-free conditions, but it is preferable to use a solvent from the perspective of synthesis stability and handling. It is also preferable to use a radical polymerization initiator (which may be abbreviated as “polymerization initiator”) from the perspective of molecular weight control. Other known additives such as chain transfer agents may be used. Solvents described later can be used as solvents.

Examples of polymerization initiators include organic peroxides such as benzoyl peroxide, tert-butyl perbenzoate, cumene hydroperoxide, diisopropyl peroxydicarbonate, di-n-propyl peroxydicarbonate, di(2-ethoxyethyl) peroxydicarbonate, tert-butyl peroxy-2-ethylhexanoate, tert-butyl peroxyneodecanoate, tert-butyl peroxybivalate, (3,5,5-trimethylhexanoyl) peroxide, dipropionyl peroxide, and diacetyl peroxide, azo compounds such as 2,2′-azobisisobutyronitrile, 2,2′-azobis (2-methylbutyronitrile), 1,1′-azobis (cyclohexane 1-carbonitrile), 2,2′-azobis (2,4-dimethylvaleronitrile), 2,2′-azobis (2,4-dimethyl-4-methoxyvaleronitrile), dimethyl 2,2′-azobis (2-methylpropionate), 4,4′-azobis (4-cyanovaleric acid), 2,2′-azobis (2-hydroxymethylpropionitrile), 2,2′-azobis [2-(2-imidazoline-2-yl) propane], and the like.

Examples of chain transfer agent include alkyl mercaptans such as octyl mercaptans, nonyl mercaptans, decyl mercaptans, and dodecyl mercaptans, thioglycolic acid esters such as octyl thioglycolate, nonyl thioglycolate, thioglycolate-2-ethylhexyle, 2,4-diphenyl-4-methyl-1-pentene, 1-methyl-4-isopropylidene-1 cyclohexene, α-pinene, β-pinene, and the like. In particular, thioglycolic acid esters such as 2,4-diphenyl-4-methyl-1-pentene, 1-methyl-4-isopropylidene-1-cyclohexene, α-pinene, β-pinene, and the like are preferable, because the resulting polymer has a low odor.

The weight-average molecular weight Mw of the acrylic polymer (A) is preferably 200,000 to 2,000,000, more preferably 300,000 to 1,200,000, and even more preferably 400,000 to 1,000,000, based on the standard polystyrene equivalent value obtained by gel permeation chromatography (GPC). When the weight-average molecular weight is 200,000 or more, a sufficient cohesive force can be achieved. Conversely, when the weight-average molecular weight is 2,000,000 or less, an increase in viscosity can be suppressed, and satisfactory coating suitability can be achieved.

The molecular weight dispersity Mw/Mn of the acrylic polymer (A) is preferably 2.0 to 12 and more preferably 4 to 10 based on the standard polystyrene equivalent value obtained by gel permeation chromatography (GPC). Within these ranges of molecular weight dispersity, it is possible to achieve a balance between pressure sensitive adhesive strength and cohesion.

The glass transition temperature (Tg) of the acrylic polymer (A) is preferably, but not particularly limited to, −70° C. to −25° C., and more preferably −65° C. to −30° C. When the glass transition temperature is −70° C. or more, a sufficient cohesive force can be achieved. Conversely, when the glass transition temperature is −25° C. or less, a satisfactory pressure sensitive adhesive force can be exhibited.

In the first embodiment, the glass transition temperature (Tg) of the acrylic polymer (A) is a value calculated based on the following Expression (11) (Fox formula).

$$1 / Tg = W 1 / Tg 1 + W 2 / Tg 2 + … + Wn / Tgn \qquad ( 11 )$$

[In Expression (11), Tg is Tg (unit: K) of the acrylic polymer (A), Tgi (i=1, 2, . . . n) is Tg (unit: K) when a radically polymerizable monomer i forms a homopolymer, and Wi (i=1, 2, . . . n) represents the mass fraction of the radically polymerizable monomer i in the total monomer component. The Tg of the homopolymer is determined using published values such as literature values or catalog values.

The above Expression (11) is a calculation formula when the acrylic polymer (A) is composed of n types of monomer components, namely, monomer 1, monomer 2, . . . , and monomer n.

### <Metal Chelate Compound (B)>

The pressure sensitive adhesive composition according to the first embodiment includes the metal chelate compound (B) as a curing agent. The metal chelate compound (B) can exhibit high pressure sensitive adhesive force and cohesive force by forming a crosslinking point with the monomer (a1) having an acidic group included in the acrylic polymer (A). Additionally, metal chelate compounds are less susceptible to the influence of water and humidity, and thus a stable cohesive force can be achieved regardless of the season and coating environment. In addition, it is preferable to use a catalyst action inhibitor (b1), which will be described later, in combination with the metal chelate compound, because it can help suppress remarkable thickening behavior even after the curing agent is blended, ensuring satisfactory pot life and long-term storage stability.

Known metal chelate compounds can be used as the metal chelate compound (B), for example, coordination compounds of polyvalent metals such as aluminum, iron, copper, zinc, tin, titanium, nickel, antimony, magnesium, vanadium, chromium, zirconium, and ligands such as acetylacetone, ethyl acetoacetate, and the like. From the perspective of long-term storage stability, the polyvalent metal is preferably aluminum, and the ligands are preferably at least one of acetylacetone and acetoacetate.

The metal chelate compound (B) is, for example, aluminum alkoxides such as aluminum isopropylate, monosec-butoxyaluminum diisopropylate, aluminum sec-butyrate, and aluminum ethylate, aluminum chelates such as ethylacetoacetate aluminum diisopropylate, aluminum tris (ethylacetoacetate), alkylacetoacetate aluminum diisopropylate, aluminum monoacetylacetate bis (ethylacetoacetate), and aluminum tris (acetylacetonate);
titanium alkoxides such as titanium tetraisopropoxide, titanium tetranormal butoxide, titanium butoxy dimer, and titanium tetra-2-ethyl hexoxide;
titanium chelates such as titanium isopropoxybis (acetylacetonate), titanium tetraacetylacetonate, titanium diisopropoxybis (ethylacetoacetate), titanium phosphate complex, and titanium octylene glycol;
zirconium alkoxides such as zirconium tetranormal propoxide and zirconium tetranormal butoxide;
zirconium chelates such as zirconium tetraacetylacetonate, zirconium tributoxymonoacetylacetonate, zirconium tetraacetylacetonate and zirconium dibutoxybis (ethylacetoacetate); and
zirconium acylates such as zirconium stearate.

Among these compounds, alkylacetoacetate aluminum diisopropylate, aluminum monoacetylacetate bis(ethylacetoacetate), and aluminum tris (acetylacetonate) are preferable from the perspective of crosslinking, pressure sensitive adhesion, transparency, and storage stability.

The content of the metal chelate compound (B) is preferably, but not particularly limited to, 0.01 to 5.0 parts by mass, more preferably 0.1 to 2.0 parts by mass, and even more preferably 0.2 to 1.0 parts by mass per 100 parts by mass of the acrylic polymer (A). When the content of the metal chelate compound (B) is 0.01 parts by mass or more, a sufficient cohesive force can be achieved, and when the content thereof is 5.0 parts by mass or less, a decrease in the pressure sensitive adhesive force can be suppressed.

<Catalyst Action Inhibitor (b1)>

In the pressure sensitive adhesive composition according to the first embodiment, the known catalyst action inhibitor (b1) is preferably added to improve the pot life of the pressure sensitive adhesive.

Specifically, an example of the catalyst action inhibitor (b1) includes a keto-enol tautomer-forming compound. The keto-enol tautomer-forming compound is a compound capable of forming a keto-enol tautomer, preferably acetylacetone, acetoacetate esters, malonic esters, and the like.

Examples of acetoacetate esters include methyl acetoacetate, ethyl acetoacetate, isopropyl acetoacetate, butyl acetoacetate, isobutyl acetoacetate, tert-butyl acetoacetate, and the like.

Examples of malonic esters include dimethyl malonate, diethyl malonate, dibutyl malonate, and the like. Among these compounds, the keto-enol tautomer-forming compound is preferably acetylacetone, because it is easily volatilized during drying.

The content of the catalyst action inhibitor (b1) is preferably 0.05 to 10.0 parts by mass, more preferably 0.1 to 5.0 parts by mass, and even more preferably 0.5 to 3.0 parts by mass per 100 parts by mass of the acrylic polymer (A). When the content of the catalyst action inhibitor (b1) is 0.05 parts by mass or more, the pot life is satisfactory, while when the content is 10.0 parts by mass or less, satisfactory initial curability is achieved.

### <Curing Agent>

In the pressure sensitive adhesive composition according to the first embodiment, other curing agents besides the metal chelate compound (B) can also be used. Examples of other curing agents include isocyanate curing agents, epoxy curing agents, or aziridine curing agents. The inclusion of these curing agents further enhances the cohesive strength of the pressure sensitive adhesive composition, leading to improved heat resistance.

Examples of isocyanate curing agents include compounds with three or more isocyanate groups within the molecule, for example, an adduct of a diisocyanate such as tolylene diisocyanate, hexamethylene diisocyanate, isophorone diisocyanate, xylylene diisocyanate, hydrogenated xylylene diisocyanate, diphenylmethane diisocyanate, tetramethyl xylylene diisocyanate, naphthalene diisocyanate, triphenylmethane triisocyanate, and polymethylene polyphenyl isocyanate with a polyol compound such as trimethylolpropane, a burette thereof, an isocyanurate thereof, and an adduct of the diisocyanate with any polyol such as polyether polyol, polyester polyol, acrylic polyol, polybutadiene polyol, and polyisoprene polyol. Alternatively, examples of isocyanate curing agents include a compound having two isocyanate groups within the molecule of these allophanates or the like. Among these compounds, a trimethylolpropane adduct of tolylene diisocyanate, a trimethylolpropane adduct of xylylene diisocyanate, and a trimethylolpropane adduct of hexamethylene diisocyanate are preferable, because their pressure sensitive adhesive properties can be easily adjusted. Note that the number of isocyanate groups is the average number.

Examples of epoxy curing agents include bisphenol A-epichlorohydrin type epoxy resins, ethylene glycol diglycidyl ether, polyethylene glycol diglycidyl ether, glycerol diglycidyl ether, glycerol triglycidyl ether, 1,6-hexanediol diglycidyl ether, trimethylolpropane triglycidyl ether, diglycidylaniline, N, N, N′, N′-tetraglycidyl-m-xylylenediamine, 1,3-bis (N, N′-diglycidylaminomethyl) cyclohexane, N, N, N′, N′-tetraglycidylaminophenylmethane, and the like.

Examples of aziridine curing agents include N, N′-diphenylmethane-4,4′-bis (1-aziridinecarboxite), N, N′-toluene-2,4-bis(1-aziridinecarboxite), bisisophthaloyl-1-(2-methylaziridine), tri-1-aziridinylphosphine oxide, N, N′-hexamethylene-1,6-bis (1-aziridinecarboxite), 2,2′-bishydroxymethylbutanol-tris [3-(1-aziridinyl) propionate], trimethylolpropane tri-o-aziridinylpropionate, tetramethylolmethane tri-o-aziridinylpropionate, tris-2,4,6-(1-aziridinyl)-1,3,5-triazine, and the like.

The content of other curing agents is preferably, but not particularly limited to, 10 parts by mass or less, and more preferably 5 parts by mass or less per 100 parts by mass of the acrylic polymer (A).

### <Polycarboxylic Acid Compound (C)>

The polycarboxylic acid compound (C) is not limited as long as it is an organic acid having two or more carboxylic acids within the molecule. By including these compounds, the speed of crosslinking between a constituent unit derived from the monomer (a1) having an acidic group constituting the acrylic polymer (A) and the metal chelate compound (B) can be greatly improved. This enables the enhancement of degree of crosslinking in a short time after coating, allowing the transition to the next step, such as punching processing, without the need for an aging period.

Specifically, examples of polycarboxylic acid compound (C) include saturated dicarboxylic acids such as malonic acid and succinic acid, unsaturated dicarboxylic acids such as maleic acid, fumaric acid, itaconic acid, citraconic acid, and mesaconic acid, hydroxy acids having two or more carboxylic acids such as citric acid and isocitric acid, aromatic-containing polycarboxylic acids such as phthalic acid, trimellitic acid, and pyromellitic acid, and alicyclic structure-containing polycarboxylic acids such as cis, trans-1, 2-cyclohexanedicarboxylic acid. The polycarboxylic acid compound (C) is preferably at least one kind of dicarboxylic acid compound selected from the group consisting of malonic acid, succinic acid, maleic acid, fumaric acid, itaconic acid, citraconic acid, mesaconic acid, phthalic acid, and cis, trans-1, 2-cyclohexanedicarboxylic acid. Among these compounds, maleic acid, phthalic acid, and fumaric acid can achieve a higher degree of crosslinking in a shorter period. Maleic acid and phthalic acid are particularly good. Maleic acid is particularly preferred.

The polycarboxylic acid compound (C) preferably has at least one acid dissociation constant pKa value in water in the range of 1.0 to 5.0, more preferably 1.0 to 3.5, and even more preferably 1.0 to 3.0. This is preferable because the degree of crosslinking can be increased in a shorter time.

Published values such as literature and catalog values can be used for acid dissociation constants, for example, maleic acid (1.92, 6.23), phthalic acid (2.98, 5.28), fumaric acid (3.02, 4.38), succinic acid (4.19, 5.48), cis-1,2-cyclohexanedicarboxylic acid (4.34, 6.76), and trimellitic acid (2.52, 3.84, 5.2).

The polycarboxylic acid compound (C) preferably has a molecular weight of 1000 or less, more preferably 400 or less, and even more preferably 300 or less. The lower limit of the molecular weight is not particularly limited, but is preferably 90 or more.

The number of carboxyl groups in the molecule is preferably 2 to 8, more preferably 2 to 4, and even more preferably 2 to 3. It is the most preferable for the compound to be a dicarboxylic acid compound.

By keeping the molecular weight or the number of carboxyl groups within the above ranges, the effect on the performance of the pressure sensitive adhesive after completion of aging can be reduced, and curing can be completed in a shorter time.

The polycarboxylic acid compound (C) is preferably a cis compound or a compound in which two carboxyl groups are in the same plane. When the polycarboxylic acid compound (C) is a cis compound or a compound in which two carboxyl groups are in the same plane, it is possible to improve the degree of crosslinking in a very short time. Specifically, examples of such compounds include maleic acid and phthalic acid.

The content of the polycarboxylic acid compound (C) is not particularly limited, but is preferably 0.01 to 10 parts by mass, more preferably 0.10 to 2.0 parts by mass, and even more preferably 0.3 to 1.5 parts by mass per 100 parts by mass of the acrylic polymer (A). With a content of 0.01 parts by mass or more, it is possible to improve the degree of crosslinking in a short period, and with a content of 10 parts by mass or less, it is possible to achieve a sufficient cohesive force and satisfactory transparency of a coated film.

### <Solvent>

The pressure sensitive adhesive composition according to the first embodiment may include a solvent. The timing of blending the solvent is not particularly limited and may be used during the production of the acrylic polymer (A). The solvent can also be used as a dilution solvent to adjust viscosity during the production of the pressure sensitive adhesive composition. Solvents can be chosen based on considerations such as leveling properties, drying properties during coating, as well as their impact on the environment and human health. Solvents such as aliphatic hydrocarbons, cycloaliphatic hydrocarbons, aromatic hydrocarbons, esters, ketones, alcohols, etc., are preferable.

Examples of solvents include ester solvent such as methyl acetate, ethyl acetate, propyl acetate, and butyl acetate, ketone solvent such as acetone, methyl ethyl ketone, methyl butyl ketone, and cyclohexanone, hydrocarbon solvents such as toluene, xylene, and anisole, and alcohol solvents such as methanol, ethanol, normal propanol, and isopropanol. However, from the perspective of the pot life of the pressure sensitive adhesive composition, it is preferable for the solvent to contain ester and/or alcohol solvents.

The amount of the solvent used is preferably 10 parts by mass or more, and more preferably 30 parts by mass or more per 100 parts by mass of the acrylic polymer (A). While there is no specific upper limit, it is preferable for the amount of the solvent to be 2000 parts by mass or less from the perspective of coatability.

### <Tackifier Resin>

The pressure sensitive adhesive composition according to the first embodiment may further include a tackifier resin. The tackifier resin may be used by any method, such as a method used for solution polymerization or a method for blending the tackifier resin into the acrylic polymer (A). When the tackifier resin is used for solution polymerization, it acts as a chain transfer agent and facilitates adjustment of the molecular weight of the acrylic polymer (A). Furthermore, the pressure sensitive adhesive strength can be improved when the tackifier resin is blended with the acrylic polymer (A).

The softening point of the tackifier resin is preferably 70° C. to 170° C., more preferably 75° C. to 160° C., and even more preferably 100° C. to 150° C.

Having the softening point of the tackifier resin in the above ranges makes it easier to achieve a high level of both pressure sensitive adhesion and cohesion. The softening point is the softening temperature measured according to the dry bulb method defined in JIS SK5902.

Examples of tackifier resin include, but are not limited to, rosin resins, polymerized rosin resins, rosin-ester resins, polymerized rosin-ester resins, terpene resins, terpene-phenol resins, coumarone resins, coumaronindene resins, styrene resins, xylene resins, phenol resins, petroleum resins, and the like. Among these resins, rosin resins, polymerized rosin resins, rosin-ester resins, polymerized rosin-ester resin, polymerized rosin-ester resins, and petroleum resins are preferable, and rosin-ester resins and polymerized rosin-ester resins are more preferable due to their good compatibility with the acrylic polymer (A), leading to improved pressure sensitive adhesive performance. As the tackifier resin, only one type of a resin may be used, or two or more types of resins may be used in combination.

The content of the tackifier resin is preferably 5 to 60 parts by mass, more preferably 10 to 40 parts by mass, and more preferably 20 to 30 parts by mass per 100 parts by mass of the acrylic polymer (A). Addition of 5 parts by mass or more of the tackifier resin enhances the pressure sensitive adhesive strength, while maintaining it at 60 parts by mass or less helps to maintain cohesion.

### <Plasticizer>

In order to suppress zipping during peeling, the pressure sensitive adhesive composition according to the first embodiment may further optionally include a plasticizer. Although the plasticizer is not particularly limited, an organic acid ester is preferable from the perspective of compatibility with the acrylic polymer (A).

Examples of esters of monobasic acids or polybasic acids with alcohols include isostearyl laurate, isopropyl myristate, isocetyl myristate, octyl dodecyl myristate, isostearyl palmitate, isocetyl stearate, octyl dodecyl oleate, dibutyl phthalate, dioctyl phthalate, diheptyl phthalate, dibenzyl phthalate, butylbenzyl phthalate, diisodecyl adipate, diisostearyl adipate, dibutyl sebacate, diisocetyl sebacate, tributyl acetylcitrate, tributyl trimelliate, trioctyl trimelliate, trihexyl trimelliate, trioleyl trimelliate, triisocetyl trimelliate, and the like.

Examples of esters of other acids with alcohols include unsaturated fatty acids such as myristoleic acid, oleic acid, linoleic acid, linolenic acid, isopalmitic acid, and isostearic acid, as well as branched acids, and esters with alcohols such as ethylene glycol, propylene glycol, glycerin, trimethylolpropane, pentaerythritol, sorbitan, and the like.

Examples of esters of monobasic acids or polybasic acids with polyalkylene glycols include polyethylene glycol dihexylate, polyethylene glycol di-2-ethylhexylate, polyethylene glycol dilaurylate, polyethylene glycol dioleate, dipolyethylene glycol methyl ether adipate, and the like.

Examples of phosphate ester plasticizers include triclylphosphate (TCP), triphenylphosphate (TPP), tri-2-ethylhexylphosphate (TOP), trixylenylphosphate (TXP), triethylphosphate (TEP), and the like.

Examples of epoxy plasticizers include epoxidized soybean oil, epoxidized linseed oil, epoxidized octyl stearate, epoxidized fatty acid butyl, epoxidized linseed oil fatty acid butyl, and the like.

The molecular weight (formula weight or Mn) of the plasticizer is preferably 250 to 1000, more preferably 400 to 900, and even more preferably 500 to 850. A molecular weight of 250 or more provides satisfactory heat resistance for a pressure sensitive adhesive layer, and a molecular weight of 1000 or less ensures a sufficient zipping suppression effect.

Although the plasticizer content is not particularly limited, 0.01 to 30 parts by mass is preferable, 0.05 to 20 parts by mass is more preferable, 0.1 to 10 parts by mass is even more preferable, and 0.3 to 5 parts by mass is most preferable per 100 parts by mass of the acrylic polymer (A). A plasticizer content of 0.01 parts by mass or more can sufficiently suppress zipping during peeling, and a plasticizer content of 30 parts by mass or less can suppress the lowering of a pressure sensitive adhesive force.

### <Antioxidant>

The pressure sensitive adhesive composition according to the first embodiment may further optionally include an antioxidant. Examples of antioxidant include radical scavengers, peroxide decomposers, and the like. Examples of radical scavenger include phenolic compounds and amine compounds. Examples of peroxide decomposers include sulfur compounds and phosphorus compounds.

Examples of phenolic compounds include 2,6-di-t-butyl-p-cresol, butylated hydroxyanisole, 2,6-di-t-butyl-4-ethylphenol, stearin-β-(3,5-di-t-butyl-4-hydroxyphenyl) propionate, 2,2′-methylenebis (4-methyl-6-t-butylphenol), 2,2′-methylenebis (4-ethyl-6-t-butylphenol), 4,4′-thiobis (3-methyl-6-t-butylphenol), 4,4′-butylidenebis (3-methyl-6-t-butylphenol), 3,9-bis [1,1-dimethyl-2-[D-(3-t-butyl-4-hydroxy-5-methylphenyl) propionyloxy] ethyl] 2,4,8,10-tetraoxaspiro[5,5]undecane, benzene propanoic acid, 3,5-bis(1,1-dimethylethyl)-4-hydroxy-, C7-C9 side chain alkyl esters, 1,1,3-tris(2-methyl-4-hydroxy-5-t-butylphenyl) butane, 1,3,5-trimethyl-2,4,6-tris (3,5-di-t-butyl-4-hydroxybenzyl) benzene, tetrakis-[methylene-3-(3′,5′-di-t-butyl-4′-hydroxyphenyl) propionate]methane, bis[3,3′-bis-(4′-hydroxy-3′-t-butylphenyl) butyric acid] glycol ester, 1,3,5-tris(3′,5′-di-t-butyl-4′-hydroxybenzyl)-S-triazine-2, 4, 6-(1H, 3H, 5H) trione, tocopherol, and the like.

Examples of sulfur antioxidants include dilauryl 3,3′-thiodipropionate, dimyristyl 3,3′-thiodipropionate, distearyl 3,3′-thiodipropionate, and the like.

Examples of phosphorus compounds include triphenylphosphite, diphenylisodecylphosphite, 4,4′-butylidene-bis(3-methyl-6-tert-butylphenylditridecyl)phosphite, cyclic neopentanetetrylbis (octadecylphosphite), tris(nonylphenyl)phosphite, tris(mononylphenyl) phosphite, tris(dinonylphenyl)phosphite, diisodecylpentaerythritol diphosphite, 9,10-dihydro-9-oxa-10-phosphaphenanthren-10-oxide, 10-(3,5-di-tert-butyl-4-hydroxybenzyl)-9,10-dihydro-9-oxa-10-phosphaphenanthren-10-oxide, 10-desiloxy-9,10-dihydro-9-oxa-10-phosphaphenanthren, tris(2,4-di-tert-butylphenyl)phosphite, cyclic neopentanetetryl bis(2,4-di-tert-butylphenyl)phosphite, cyclic neopentanetetryl bis(2,6-di-tert-butyl-4-methylphenyl)phosphite, 2,2-methylenebis(4,6-di-tert-butylphenyl)octylphosphite, and the like.

By using an antioxidant, thermal degradation of the acrylic polymer (A) can be prevented, and heat resistance can be improved.

The amount of the antioxidant added is not particularly limited and preferably, it is 0.01 to 5 parts by mass, more preferably, it is 0.1 to 3 parts by mass, and even more preferably, it is 0.2 to 2 parts by mass per 100 parts by mass of the acrylic polymer (A).

As the antioxidant, a phenolic compound which is a radical scavenger is preferable from the perspective of transparency and polymerization inhibition effect. The phenolic compounds can effectively suppress residual monomer components during synthesis of acrylic polymer (A), which generate low molecular weight components over time and reduce heat resistance.

### <Other Additives>

The pressure sensitive adhesive compositions according to the first embodiment may further include, as needed, known additives such as catalysts, antistatic agents (AS agents), ultraviolet absorbers, light stabilizers, lubricants, corrosion inhibitors, heat stabilizers, weather stabilizers, hydrolysis inhibitors, mildewproof agents, thickeners, fillers (talc, calcium carbonate, titanium oxide, etc.), silane coupling agents, polymerization inhibitors, antifoaming agents, slip agents, antiblocking agents, antifogging agents, gliding agents, dyes, waxes, emulsions, magnetic materials, dielectric property regulators, or the like, which may be blended as necessary.

### <Method for Manufacturing Pressure Sensitive Adhesive Composition>

The method for manufacturing the pressure sensitive adhesive composition according to the first embodiment is not particularly limited.

The pressure sensitive adhesive according to the first embodiment can be produced by adding the metal chelate compound (B), the polycarboxylic acid compound (C), a solvent, and, if necessary, an optional component to the acrylic polymer (A) and mixing them.

The pressure sensitive adhesive composition according to the first embodiment preferably has a non-volatile content concentration of 30 to 75 mass %, more preferably 38 to 65 mass %, and even more preferably 40 to 60 mass %. By setting the non-volatile content concentration of the pressure sensitive adhesive composition high, the solvent content can be relatively suppressed. This, in turn, contributes to cost reduction during coating and drying, as well as minimizing environmental and human health impacts.

The viscosity of the pressure sensitive adhesive composition at 25° C. is preferably 1000 to 20,000 mPa·s, more preferably 1500 to 10,000 mPa·s and more preferably 2500 to 7000 mPa·s. Having the viscosity of the pressure sensitive adhesive composition in the above ranges improves coatability and facilitates the formation of a smooth pressure sensitive adhesive layer. The viscosity is measured at 25° C. ambient temperature using a BL-type viscometer with a #3 rotor, rotating at a speed of 12 rpm, and measured one minute after the start of rotation.

### <<Pressure Sensitive Adhesive Sheet>>

The pressure sensitive adhesive sheet includes a substrate and a pressure sensitive adhesive layer composed of a cured product of the pressure sensitive adhesive composition according to the first embodiment. The pressure sensitive adhesive layer may be formed on one or both sides of the substrate. Optionally, the exposed surface of the pressure sensitive adhesive layer may be coated with a release sheet. The release sheet is released when the pressure sensitive adhesive sheet is adhered to the adherend.

When the pressure sensitive adhesive composition is applied, the viscosity can be adjusted using the aforementioned solvent, or the viscosity can be reduced by heating the pressure sensitive adhesive composition.

The substrate is not particularly limited, and examples thereof include resin sheets, paper, and metal foils. The substrate may be a laminated sheet with one or more layers laminated on at least one side of these substrates. On the side of the substrate where the pressure sensitive adhesive layer is formed, if necessary, easy pressure sensitive adhesion treatments such as corona discharge treatment and application of anchor coat agents may be applied.

Constituent resins of the resin sheet are not particularly limited and examples thereof include ester resins such as polyethylene terephthalate (PET); olefin resins such as polyethylene (PE) and polypropylene (PP); vinyl resins such as polyvinyl chloride; amide resins such as nylon 66; urethane resins (including foams); and combinations thereof.

The thickness of the resin sheet excluding the polyurethane sheet is not particularly limited and is preferably 15 to 300 μm. The thickness of the polyurethane sheet (including the foam) is not particularly limited and is preferably 20 to 50,000 μm.

The paper is not particularly limited and examples thereof include plain paper, coated paper, and art paper.

The constituent metals of the metal foil are not particularly limited and examples thereof include aluminum, copper, and combinations thereof.

The release sheet is not particularly limited and a known release sheet having a known release treatment such as a release agent coating applied to the surface of a substrate sheet such as a resin sheet or paper can be used.

The pressure sensitive adhesive sheet can be produced by a known method.

First, the pressure sensitive adhesive composition according to the first embodiment is applied on the surface of the substrate to form a coating layer composed of the pressure sensitive adhesive composition agent according to the first embodiment. Known coating methods can be employed, and examples thereof include a roll coater method, a comma coater method, a die coater method, a reverse coater method, a silk screen method, and a gravure coater method.

Next, the coating layer is dried and cured to form a pressure sensitive adhesive layer composed of the cured product of the pressure sensitive adhesive composition according to the first embodiment. The heating and drying temperature is not particularly limited and is preferably about 60 to 150° C. The thickness of the pressure sensitive adhesive layer (thickness after drying) varies depending on the application, but is preferably 0.1 to 200 μm.

Next, if necessary, a release sheet is attached to the exposed surface of the pressure sensitive adhesive layer by a known method.

The single-sided pressure sensitive adhesive sheet can be produced as described above. By performing the above operation on both sides, the double-sided pressure sensitive adhesive sheet can be produced.

Contrary to the above method, the pressure sensitive adhesive composition according to the first embodiment may be applied on the surface of the release sheet to form a coating layer composed of the pressure sensitive adhesive composition according to the first embodiment, and then the coating layer may be dried and cured to form a pressure sensitive adhesive layer composed of a cured product of the pressure sensitive adhesive composition according to the first embodiment, and the substrate sheet may be laminated on the exposed surface of the pressure sensitive adhesive layer.

The method for producing a pressure sensitive adhesive sheet preferably includes a coating step in which a pressure sensitive adhesive is applied on the substrate, a heating step in which the formed coating layer is subjected to a heating and drying treatment to form a pressure sensitive adhesive layer containing a cured product of the pressure sensitive adhesive, a winding step in which the obtained adhesive sheet is wound on a winding core to form a pressure sensitive adhesive sheet roll, and a curing step in which the pressure sensitive adhesive sheet roll is cured.

### Second Embodiment

### <<Pressure Sensitive Adhesive Composition>>

A pressure sensitive adhesive composition according to a second embodiment includes an acrylic polymer (A) and a metal chelate compound (B). The acrylic polymer (A) is a copolymer of a monomer mixture including a monomer (a1) with an acidic group. The content of the monomer (a1) with an acidic group is 0.01 mass % or more and 20 mass % or less in 100 mass % of the monomer mixture, and a gel fraction rate (P) of toluene and ethyl acetate represented by Expression (21) is 0.2 or more.

(P)=(Gel fraction rate (Y) when toluene is used as extraction solution)/(gel fraction rate (X) when ethyl acetate is used as extraction solution) (21).

According to the second embodiment, it is possible to provide a pressure sensitive adhesive composition that not only has high processability and sufficient pressure sensitive adhesive properties without an aging period, but also has a small fluctuation in performance immediately after coating and after long-term storage, is excellent in storage stability of a coating liquid, and can be used stably for a long period even after a curing agent is blended.

### <Gel Fraction Rate>

The gel fraction rate is calculated by the following Expression (22).

$$( gel fraction rate ) = \{ ( W 2 - W 0 - W 3 ) / ( W 1 - W 0 - W 3 ) \} \times 100 \\ W 0 : Weight of wire mesh \\ W 1 : Weight of wire mesh + specimen \\ W 2 : Weight of wire mesh + specimen after drying \\ W 3 : Weight of the substrate of the specimen \qquad ( 22 )$$

The method for measuring the gel fraction rate is described in detail in the Example section.

The gel fraction rate after 7 days of coating when ethyl acetate is used as an extraction solution is not particularly limited, but is preferably 10% to 95%, more preferably 20% to 85%, and particularly preferably 30% to 80%. Satisfactory processability can be achieved by making the gel fraction rate of ethyl acetate 5% or more. In addition, by making the gel fraction rate of ethyl acetate 95% or less, high pressure sensitive adhesion can be achieved even after 5 hours of coating.

### <Gel Fraction Rate of Toluene and Ethyl Acetate (P)>

The gel fraction rate of toluene and ethyl acetate (P) is calculated by the following Expression (21) based on the gel fraction of each extraction solution calculated by the Expression (22).

(P)=(gel fraction rate (Y) when toluene is used as extraction solution)/(gel fraction rate (X) when ethyl acetate is used as extraction solution) (21)

The value of (P) after 7 days of coating in the second embodiment is 0.20 or more. The value of (P) is, preferably, 0.30 or more and 0.98 or less, and more preferably, 0.60 or more and 0.96 or less. A value of (P) of 0.2 or more allows for satisfactory processability even immediately after coating.

### <Acrylic Polymer (A)>

The acrylic polymer refers to a polymer of a monomer having an ethylenically unsaturated bond such as a (meth)acrylic acid ester monomer. The acrylic polymer (A) is a copolymer of a monomer mixture including at least the monomer (a1) having an acidic group. The content of the monomer (a1) having an acidic group is 0.01 mass % or more and 20 mass % or less in 100 mass % of the monomer mixture.

The monomers are classified into the monomer (a1) having an acidic group, the (meth)acrylic acid alkyl ester monomer (a2), and other monomers other than the monomers (a1) and (a2). As the monomer constituting the acrylic polymer (A), the monomer (a1) is used as an essential component, and further the monomer (a2) is preferably used, and other monomers may be used as necessary.

[Monomer (a1)]

By using the monomer (a1), a polymer network is formed by a cross-linking reaction with a reactive functional group of the metal chelate compound (B) described later, and thus a cohesive force of the acrylic polymer (A) can be enhanced. The description of the monomer (a1) in the first embodiment is incorporated into the specific example of the monomer (a1). However, as a preferred example of the monomer (a1) having an acidic group, in addition to (meth)acrylic acid and 2-carboxyethyl(meth)acrylate, maleic acid is also suitable in terms of cohesion strength and reactivity with the metal chelate compound (B) of the resulting pressure sensitive adhesive composition, and copolymerization compatibility with other monomers.

The content of the monomer (a1) in 100 mass % of the monomer mixture constituting the acrylic polymer (A) and its suitable range, etc. are incorporated by reference to the description of [Monomer (a1)] in the first embodiment.

[Monomer (a2)]

The monomer (a2) is a (meth)acrylic acid alkyl ester monomer.

As the (meth)acrylic acid alkyl ester monomer, a (meth)acrylic acid alkyl ester monomer with an alkyl group of 1 to 12 carbon atoms is preferably used. The (meth)acrylic acid alkyl ester monomer is further classified into (meth)acrylic acid alkyl ester monomer with an alkyl group of 1 to 3 carbon atoms (a2x), (meth)acrylic acid alkyl ester monomer with an alkyl group of 4 to 12 carbon atoms (a2y), and (meth)acrylic acid alkyl ester monomer with an alkyl group of 13 or more carbon atoms (a2z). The monomer (a2) is preferably (a2y) and more preferably (a2x) and (a2y) are used together.

The content of the monomer (a2) is preferably, but not particularly limited to, 20 mass % or more and 99.9 mass % or less, and more preferably 50 mass % to 98 mass % in 100 mass % of the monomer mixture constituting the acrylic polymer (A). This range allows for achieving a balance between high pressure sensitive adhesion and high cohesion.

The content of the monomer (a2x) is preferably, but not particularly limited to, 5 mass % or more and 85 mass % or less, more preferably 5 mass % or more and 50 mass % or less, and even more preferably 10 mass % or more and 30 mass % or less in the monomer (a2). When the content of the monomer (a2) is 5 mass % or more, a high cohesive force can be exhibited.

The content of the monomer (a2y) is preferably, but not particularly limited to, 15 mass % or more and 95 mass % or less, more preferably 15 mass % or more and 94.9 mass % or less, and even more preferably 50 mass % or more and 90 mass % or less in the monomer (a2). When the content of the monomer (a2y) is 15 mass % or more and 94.9 mass % or less, a high pressure sensitive adhesive force can be exhibited.

Specific and preferred examples of the monomer (a2x), the monomer (a2y), and the monomer (a2z) are incorporated by reference to the description of the monomer (a2) in the first embodiment.

### [Other Monomers]

Other monomers refer to monomers other than the monomer (a1) and the monomer (a2). As for other monomers, there are no specific limitations, and suitable monomers that can copolymerize with the monomer (a1) and the monomer (a2) can be chosen as needed. Other monomers include, for example, vinyl carboxylic acid monomers such as vinyl acetate, vinyl propionate, and vinyl butyrate, other vinyl monomers such as styrene, and acrylonitril, monomers with aliphatic cyclic structures such as isobutyl (meth)acrylate, and cyclohexyl (meth)acrylate, monomers with aromatic rings such as phenyl (meth)acrylate, phenoxyethyl (meth)acrylate, benzyl (meth)acrylate, and biphenyl (meth)acrylate, monomers with alkoxy(poly)alkylene oxide such as 2-methoxyethyl acrylate, 2-ethoxyethyl acrylate, methoxy polyethylene glycol (meth)acrylate, methoxy polypropylene glycol (meth)acrylate, ethoxy polypropylene glycol (meth)acrylate, acid anhydrides with polymerizable unsaturated bonds in the molecule, monomers with hydroxyl groups, monomers with amino groups, monomers with other nitrogen atoms, monomers with epoxy groups, monomers with isocyanate groups, and the like.

Specific examples of monomers with hydroxyl groups, monomers with amino groups, monomers with other nitrogen atoms, monomers with epoxy groups, monomers with isocyanate groups are incorporated by reference to the description of [Other monomers] in the first embodiment.

### [Method for Producing Acrylic Polymer (A)]

The description of [Method for producing acrylic polymer (A)] of the first embodiment is incorporated herein.

### <Metal Chelate Compound (B)>

The description of <Metal chelate compound (B)> of the first embodiment is incorporated herein.

<Catalyst Action Inhibitor (b1)>

The description of <Catalyst action inhibitor (b1)> of the first embodiment is incorporated herein.

### <Curing Agent>

The description of <Curing agent> of the first embodiment is incorporated herein.

### <Polycarboxylic Acid Compound (C)>

The pressure sensitive adhesive composition according to the second embodiment preferably further comprises a polycarboxylic acid compound (C). The polycarboxylic acid compound (C) is not limited as long as it is an organic acid having two or more carboxylic acids within the molecule. By including these compounds, the rate of crosslinking formation between a constituent unit derived from the monomer (a1) having an acidic group constituting the acrylic polymer (A) and the metal chelate compound (B) can be greatly improved.

The polycarboxylic acid compound (C) preferably includes at least one kind selected from a group consisting of saturated dicarboxylic acids, unsaturated dicarboxylic acids, aromatic-containing polycarboxylic acids, and aliphatic cyclic structure-containing polycarboxylic acids. Specifically, examples include saturated dicarboxylic acids such as malonic acid and succinic acid, unsaturated dicarboxylic acids such as maleic acid, fumaric acid, itaconic acid, citraconic acid and mesaconic acid, aromatic-containing polycarboxylic acids such as phthalic acid, trimellitic acid and pyromellitic acid, and alicyclic structure-containing polycarboxylic acids such as cis, trans-1,2-cyclohexanedicarboxylic acid are mentioned. Among these compounds, malonic acid, succinic acid, maleic acid, phthalic acid and fumaric acid are preferable, because they can enhance processability in a shorter time.

The polycarboxylic acid compound (C) preferably has at least one acid dissociation constant pKa value in water in the range of 1.0 to 5.0, more preferably 1.0 to 3.5, and even more preferably 1.0 to 3.0. This is preferable because the processability can be enhanced in a shorter time.

Published values such as literature and catalog values can be used for acid dissociation constants, for example, maleic acid (1.92, 6.23), phthalic acid (2.98, 5.28), fumaric acid (3.02, 4.38), succinic acid (4.19, 5.48), cis-1, 2-cyclohexanedicarboxylic acid (4.34, 6.76), and trimellitic acid (2.52, 3.84, 5.2).

The polycarboxylic acid compound (C) preferably has a molecular weight of 1000 or less, more preferably 400 or less, and even more preferably 300 or less. The upper limit of the molecular weight is not particularly limited, but is preferably 100,000 or less and more preferably 10,000 or less.

The number of carboxyl groups in the molecule is preferably 2 to 8, more preferably 2 to 4, and even more preferably 2 to 3. It is the most preferable for the compound to be a dicarboxylic acid compound.

By keeping the molecular weight or the number of carboxyl groups within the above ranges, the effect on the performance of the pressure sensitive adhesive composition can be reduced, and curing can be completed in a shorter time.

The content of the polycarboxylic acid compound (C) is not particularly limited, but is preferably 0.010 to 9.0 parts by mass, more preferably 0.030 to 2.0 parts by mass, and even more preferably 0.10 to 1.0 parts by mass per 100 parts by mass of the acrylic polymer (A). With a content of 0.010 parts by mass or more, it is possible to improve the degree of crosslinking in a short period, and having it below 10 parts by mass allows for sufficient cohesion and satisfactory transparency of a coated film.

The polycarboxylic acid compound (C) may be an unreacted product of the monomer (a1) constituting the acrylic copolymer (A). Specifically, an example of the polycarboxylic acid compound that can be used as the monomer (a1) constituting the acrylic copolymer (A) includes a polycarboxylic acid having an unsaturated bond such as maleic acid, itaconic acid, fumaric acid, citraconic acid, and mesaconic acid.

The polycarboxylic acid compound (C) includes a compound having an acid anhydride skeleton and hydrolyzed by adding water. Examples of compound having an acid anhydride skeleton include succinic anhydride, allylsuccinic anhydride, maleic anhydride, itaconic anhydride, and the like. The compound having an acid anhydride skeleton may be an unreacted product of other monomers constituting the aforementioned acrylic copolymer (A). Other compounds having an acid anhydride skeleton that can be used as monomers constituting the acrylic copolymer (A) include an acid anhydride having a polymerizable unsaturated bond within the molecule such as allyl succinic anhydride and maleic anhydride.

### <Solvent>

The description of <Solvent> in the first embodiment is incorporated herein.

### <Tackifier Resin>

The description of <Tackifier resin> in the first embodiment is incorporated herein.

### <Plasticizer>

The description of <Plasticizer> in the first embodiment is incorporated herein.

### <Antioxidant>

The description of <Antioxidant> in the first embodiment is incorporated herein.

### <Other Additives>

The description of <Other additives> in the first embodiment is incorporated herein.

### <Method for Producing Pressure Sensitive Adhesive Composition>

The method for producing the pressure sensitive adhesive composition according to the second embodiment is incorporated by reference to the description of the method for producing the pressure sensitive adhesive composition according to the first embodiment. However, in the second embodiment, the polycarboxylic acid compound (C) is an optional component.

### <<Pressure Sensitive Adhesive Sheet>>

The description of the <<Pressure Sensitive Adhesive Sheet>> in the first embodiment is incorporated herein.

### EXAMPLE

A synthetic example, an example according to the present disclosure, and a comparative example will be described below. In the following description, unless otherwise specified, “part” means parts by mass, “%” means a mass %, and “RH” means relative humidity.

### [Measurement of Weight-Average Molecular Weight (Mw)]

Weight-average molecular weight (Mw) was measured by the gel permeation chromatography (GPC) method. The measurement conditions were as follows. Mw is expressed in polystyrene equivalent values.

### <Measurement Conditions>

Apparatus: LC-GPC system “Prominence” manufactured by Shimadzu Corporation,

Column: 4 GMHXLs manufactured by Tosoh Corporation, 1 HXL-H manufactured by Tosoh Corporation, connected in series;

Detector: Differential refractive index detector (RID-10 A)

Solvent: Tetrahydrofuran (THF)

Flow rate: 1 mL/min

Solvent temperature: 40° C.

Sample concentration: 0.2%

Sample injection volume: 100 μL

### [Polycarboxylic Acid Compound (C) Content]

When a polycarboxylic acid compound or its anhydride was used as a monomer component, the content of the polycarboxylic acid compound not incorporated into the acrylic polymer was measured by gas chromatography. The measurement conditions were as follows.

### <Measurement Conditions>

Apparatus: “GC-4000PLUS” manufactured by GL Sciences Inc.

Column: “InterCap AQUATIC” manufactured by GL Sciences Inc.

Detector: Flame ionization detector

Carrier: Helium

Flow rate: 1 mL/min

Split flow rate: 100 mL/min

Purge flow rate: 5 mL/min

Inlet temperature: 200° C.

Detector temperature: 250° C.

Column temperature: 40 to 200° C., Ramp rate: 7° C./min

Sample concentration: 10%

Sample injection volume: 1 μL

The following materials were used.

### <Metal Chelate Compound (B)>

AL-A: Aluminum chelate A, Aluminum tris (acetylacetonate), manufactured by Kawaken Fine Chemical Co., Ltd.

AL-D: Aluminum chelate D, Aluminum monoacetyl acetate bis (ethyl acetoacetate), manufactured by Kawaken Fine Chemical Co., Ltd.

### <Other Curing Agents>

TDI-TMP: Trimethylolpropane adduct of tolylene diisocyanate

### <Polycarboxylic Acid Compound (C)>

MAC: Maleic acid pKa=1.92, 6.23, Molecular weight=116.1, Number of carboxylic acids in molecule=2

PHA: Phthalic acid pKa=2.98, 5.28, Molecular weight=166.1, Number of carboxylic acids in molecule=2

FMA: Fumaric acid pKa=3.02, 4.38, Molecular weight=116.1, Number of carboxylic acids in molecule=2

SCA: Succinic acid pKa=4.19, 5.48, Molecular weight=118.1, Number of carboxylic acids in molecule=2

CHDA: cis-1,2-cyclohexanedicarboxylic acid, pKa=4.34, 6.76, Molecular weight=172.2, Number of carboxylic acids in molecule=2

MLA: malonic acid pKa=2.83, 5.69, Molecular weight=104.1, Number of carboxylic acids in molecule=2

TMA: trimellitic acid pKa=2.52, 3.84, 5.2, Molecular weight=210.1, Number of carboxylic acids in molecule=3

CTA: Citric acid pKa=3.09, 4.75, 5.41, Molecular weight=192.1, Number of carboxylic acids in molecule=3

<Catalyst Action Inhibitor (b1)>

AcAc: Acetylacetone

### <Other Additives>

AA: Acrylic acid

KE100: Tackifier resin Pine crystal KE100, Ultra pale rosin ester, Arakawa Chemical Arakawa Chemical Industries, Ltd.

### <Production of Acrylic Polymers>

### (Acrylic Polymer (1A-1))

In a reaction vessel including a stirrer, a thermometer, a reflux cooling tube, a dropping funnel, and a nitrogen introduction tube (hereinafter referred to simply as “reaction vessel”), 10 parts of butyl acrylate, 30 parts of 2-ethylhexyl acrylate, 2.5 parts of methyl acrylate, 2.5 parts of ethyl acrylate, 4 parts of acrylic acid, 1 part of 2-hydroxyethyl acrylate, 60 parts of ethyl acetate, and 0.02 parts of 2, 2′-azobisisobutyronitrile (AIBN) were charged. After the charging, the air inside the reaction vessel was replaced with nitrogen gas. Furthermore, 10 parts of butyl acrylate, 30 parts of 2-ethylhexyl acrylate, 2.5 parts of methyl acrylate, 2.5 parts of ethyl acrylate, 4 parts of acrylic acid, 1 part of 2-hydroxyethyl acrylate, 60 parts of ethyl acetate, and 0.02 parts of 2,2′-azobisisobutyronitrile (AIBN) were charged into a dropping funnel. Next, the reaction vessel was heated to 80° C. under a nitrogen atmosphere with stirring, and after initiating the reaction, the content of the dropping funnel was added dropwise over 2 hours, and polymerization reaction was carried out for 8 hours at a reflux temperature under a nitrogen atmosphere. After the completion of the reaction, the mixture was cooled, and diluted with isopropyl alcohol, and a 35% non-volatile acrylic polymer (1A-1) solution was obtained. The weight-average molecular weight (Mw) of the acrylic polymer (1A-1) was 630,000.

### (Acrylic Polymer (1A-2-1A-10, 1 A′-1))

Each acrylic polymer (1A-2 to 1A-10, 1A′-1) was synthesized in the same manner as the acrylic polymer (1A-1), except that the composition and blending amounts (in parts by mass) in Table 1 were changed.

TABLE 1

| | | | | | | | | | Weight- |
|---|---|---|---|---|---|---|---|---|---|
| | Acrylic copolymer | | | | | | | | average |
| | | | | | Other | | | (a1) | molecular |
| Acrylic | Monomer (a2y) | | Monomer (a2x) | | monomers | Monomer (a1) | | Content | weight |
| polymer | BA | 2EHA | MA | EA | HEA | AA | β-CEA | [%] | Mw |
| (1A-1) | 20 | 60 | 5 | 5 | 2 | 8 | | 8 | 630,000 |
| (1A-2) | 20 | 60 | 7 | 5 | | | 8 | 8 | 600,000 |
| (1A-3) | 20 | 64.5 | 7 | 5 | 0.5 | 3 | | 3 | 550,000 |
| (1A-4) | 20 | 60 | 7 | 5 | | 8 | | 8 | 630,000 |
| (1A-5) | 20 | 67.97 | 7 | 5 | | 0.03 | | 0.03 | 510,000 |
| (1A-6) | 20 | 67 | 7 | 5 | | 1 | | 1 | 520,000 |
| (1A-7) | 20 | 65.5 | 7 | 5 | | 2.5 | | 2.5 | 520,000 |
| (1A-8) | 20 | 58 | 7 | 5 | | 10 | | 10 | 540,000 |
| (1A-9) | 20 | 52 | 7 | 5 | | 16 | | 16 | 590,000 |
| (1A-10) | 20 | 48 | 7 | 5 | | 20 | | 20 | 610,000 |
| (1A′-1) | 20 | 60 | 5 | 5 | 10 | | | 0 | 640,000 |

The abbreviations listed in Table 1 and Table 4 below are as follows.

BA: butyl acrylate

2EHA: 2-ethylhexyl acrylate

MA: Methyl acrylate

BA: Ethyl acrylate

HEA: Hydroxyethyl acrylate

(Monomer with Acidic Group (a1))

AA: Acrylic acid

β-CEA: 2-carboxyethyl acrylate

MAH: Maleic anhydride

### Example 1-1

### <Production of Pressure Sensitive Adhesive Composition>

For 100 parts of an acrylic polymer (1A-1), 0.5 parts of AL-A (Aluminum chelate A, aluminum tris (acetylacetonate), manufactured by Kawaken Fine Chemical Co., Ltd.) as the metal chelate compound (B), 0.5 parts of maleic acid as the polycarboxylic acid compound (C), and 0.8 parts of acetylacetone as the catalyst action inhibitor (b1) were blended on a non-volatile basis, and ethyl acetate was incorporated as a solvent so that the non-volatile content was 30%, and the mixture was thoroughly mixed to obtain the pressure sensitive adhesive composition.

### <Production of Pressure Sensitive Adhesive Sheet>

The obtained pressure sensitive adhesive composition was coated with the pressure sensitive adhesive obtained above so that the thickness after drying was 25 μm on a release-treated surface of a releasable sheet (made of polyethylene terephthalate, hereinafter referred to as “releasable film substrate”) having a thickness of 38 μm, and dried in a hot air oven at 100° C. for 90 seconds to create a pressure sensitive adhesive layer. After the drying, the pressure sensitive adhesive layer was laminated on a substrate (made of polyethylene terephthalate) having a thickness of 50 μm, and further cured at 23° C. and −50% RH for 7 days to obtain a pressure sensitive adhesive sheet.

### Example 1-2 to 1-33, Comparative Example 1-1 to 1-4

Each of the pressure sensitive adhesive composition and pressure sensitive adhesive sheet was produced in the same manner as the pressure sensitive adhesive sheet of Example 1-1, except that the compositions and the blending amounts (in parts by mass) shown in Table 2 were changed.

TABLE 2

| | | | | | | | | | | | | Catalyst | | |
|---|---|---|---|---|---|---|---|---|---|---|---|---|---|---|
| | | | Curing agent | | | | | | | | | action | | |
| | | | Metal chelate | | Other | | | | | | | inhibitor | Other | |
| | | Acrylic | compound (B) | | curing agent | Polycarboxylic acid compound (C) | | | | | | (b1) | additives | |
| | | polymer | AL-A | AL-D | TDI-TMP | MAC | PHA | FMA | SCA | CHDA | TMA | AcAc | AA | KE100 |
| Example | 1-1 | (1A-1) | 0.5 | | | 0.5 | | | | | | 0.8 | | |
| | 1-2 | (1A-2) | 0.5 | | | 0.5 | | | | | | 0.8 | | |
| | 1-3 | (1A-3) | 0.5 | | | 0.5 | | | | | | 0.8 | | |
| | 1-4 | (1A-1) | 0.5 | | | 0.5 | | | | | | | | |
| | 1-5 | (1A-6) | 0.5 | | | 0.5 | | | | | | 0.8 | | |
| | 1-6 | (1A-7) | 0.5 | | | 0.5 | | | | | | 0.8 | | |
| | 1-7 | (1A-8) | 0.5 | | | 0.5 | | | | | | 0.8 | | |
| | 1-8 | (1A-9) | 0.5 | | | 0.5 | | | | | | 0.8 | | |
| | 1-9 | (1A-4) | 0.3 | | | 0.5 | | | | | | 0.8 | | |
| | 1-10 | (1A-4) | 0.5 | | | 0.5 | | | | | | 0.8 | | |
| | 1-11 | (1A-4) | 1 | | | 0.5 | | | | | | 0.8 | | |
| | 1-12 | (1A-4) | | 0.8 | | 0.5 | | | | | | 0.8 | | |
| | 1-13 | (1A-4) | 0.5 | | | 0.3 | | | | | | 0.8 | | |
| | 1-14 | (1A-4) | 0.5 | | | 1 | | | | | | 0.8 | | |
| | 1-15 | (1A-4) | 0.5 | | | 1.5 | | | | | | 0.8 | | |
| | 1-16 | (1A-4) | 0.5 | | | | 0.5 | | | | | 0.8 | | |
| | 1-17 | (1A-4) | 0.5 | | | | | 0.5 | | | | 0.8 | | |
| | 1-18 | (1A-4) | 1 | | | 0.5 | | | | | | 0.8 | | 15 |
| | 1-19 | (1A-4) | 0.5 | | | 0.08 | | | | | | 0.8 | | |
| | 1-20 | (1A-4) | 0.5 | | | 3 | | | | | | 0.8 | | |
| | 1-21 | (1A-4) | 0.5 | | | 9 | | | | | | 0.8 | | |
| | 1-22 | (1A-4) | 0.5 | | | | | | 0.5 | | | 0.8 | | |
| | 1-23 | (1A-4) | 0.5 | | | | | | | 0.5 | | 0.8 | | |
| | 1-24 | (1A-4) | 0.5 | | | | | | | | 0.5 | 0.8 | | |
| | 1-25 | (1A-4) | 0.5 | | | | | | 0.08 | | | 0.8 | | |
| | 1-26 | (1A-4) | 0.5 | | | | | | | 0.08 | | 0.8 | | |
| | 1-27 | (1A-4) | 0.5 | | | | | | | | 0.08 | 0.8 | | |
| | 1-28 | (1A-5) | 0.5 | | | | | | 0.08 | | | 0.8 | | |
| | 1-29 | (1A-6) | 0.5 | | | | | | 0.08 | | | 0.8 | | |
| | 1-30 | (1A-7) | 0.5 | | | | | | 0.08 | | | 0.8 | | |
| | 1-31 | (1A-8) | 0.5 | | | | | | 0.08 | | | 0.8 | | |
| | 1-32 | (1A-9) | 0.5 | | | | | | 0.08 | | | 0.8 | | |
| | 1-33 | (1A-10) | 0.5 | | | | | | 0.08 | | | 0.8 | | |
| Comparative | 1-1 | (1A-4) | 0.5 | | | | | | | | | 0.8 | | |
| Example | 1-2 | (1A′-1) | 0.5 | | | 0.5 | | | | | | 0.8 | | |
| | 1-3 | (1A-4) | 0.5 | | | | | | | | | 0.8 | 0.5 | |
| | 1-4 | (1A-3) | | | 3 | 0.5 | | | | | | | | |

### [Evaluation Items and Evaluation Methods]

The pressure sensitive adhesive composition and pressure sensitive adhesive sheet obtained were evaluated in the following manner. The results are shown in Table 3.

### (Gel Fraction Rate)

After coating the substrate, specimens 30 mm in width and 100 mm in length were cut from the pressure sensitive adhesive sheet cured under an atmosphere of −50% RH at 23° C. for 5 hours, 24 hours, and 7 days, and the weight of the specimens was measured. The release sheet was peeled off from the specimen, the exposed pressure sensitive adhesive layer was attached to a stainless steel wire mesh with a mesh count of 300. The wire mesh was folded to prevent the specimen from peeling, the specimen was immersed in ethyl acetate with the specimen wrapped with the wire mesh, and the specimen was left at 50° C. for 24 hours. After the immersion, the wire mesh was removed, washed with a small amount of ethyl acetate, dried at 100° C. for 30 minutes, and the weighed. The gel fraction rate was calculated by the following Expression (12):

$$( G el fraction rate ) = \{ ( W 2 - W 0 - W 3 ) / ( W 1 - W 0 - W 3 ) \} \times 100 \\ W 0 : Weight of wire mesh \\ W 1 : Weight of wire mesh + specimen \\ W 2 : Weight of wire mesh + specimen after drying \\ W 3 : Weight of the substrate of the specimen \qquad ( 12 )$$

### (Degree of Crosslinking)

The degree of completion of the cross-linking was calculated from the following Expressions (13) and (14) using the gel fraction rate obtained from each of the pressure sensitive adhesive sheets after coating and curing it under an atmosphere of −50% RH at 23° C. for 5 hours, 24 hours, and 7 day.

The evaluation criteria for the degree of crosslinking were as follows.

It can be said that the higher the degree of crosslinking within a short time from the coating, the better the aging resistance.

Although the gel fraction rate after 7 days is not particularly limited, it is preferably 10% or more and less than 100%, more preferably 20% or more and less than 80%, and more preferably 30% or more and less than 70% in order to exhibit a sufficient cohesive force.

(Degree of crosslinking after 5 hours)={(gel fraction rate after 5 hours of curing)/(gel fraction rate after 7 days of curing)×100} (13)

(Degree of crosslinking after 24 hours)={(gel fraction rate after 24 hours of curing)/(gel fraction rate after 7 days of curing)×100} (14)

[Evaluation criteria]

+++: 90% or more and 100% or less, Excellent.

++: 50% or more and less than 90%, Good.

+: 10% or more and less than 50%, Practically usable.

NG: Less than 10%, Not practically usable.

### (Holding Force)

Specimens of 25 mm in width and 150 mm in length were cut from a pressure sensitive adhesive sheet after 1 week of curing under an atmosphere of −50% RH at 23° C. The exposed pressure sensitive adhesive layer, obtained by peeling off the releasable sheet from the cut pressure sensitive adhesive sheet, was attached to a 30 mm wide and 150 mm long SUS plate at the lower end part with a 25 mm wide and 25 mm long. After the pressure sensitive adhesive layer was crimped with one round of pressure by a 2 kg roller, a load 1 kg weight was applied to the bottom edge of the pressure sensitive adhesive sheet at an atmosphere of 70° C., and the SUS plate was left undisturbed for 70,000 seconds to measure the holding force. The evaluation involved measuring the length by which the upper end of the attached surface of the pressure sensitive adhesive sheet had shifted downward from its original position. The evaluation criteria were as follows:

### [Evaluation Criteria]

+++: Shift length was less than 0.5 mm, Excellent.

++: Shift length was 0.5 mm or more and 5 mm or less, Good.

+: Shift length was 5 mm or more and less than 25 mm, Practically usable.

NG: Shift length was 25 mm or more, and it fell within 70,000 seconds, Not usable.

(Peeling State after Measurement of Pressure Sensitive Adhesive Force)

Specimens of 25 mm in width and 150 mm in length were cut from a pressure sensitive adhesive sheet after 1 week of curing under an atmosphere of −50% RH at 23° C. The exposed pressure sensitive adhesive layer, obtained by peeling off the releasable sheet from the cut pressure sensitive adhesive sheet, was attached to a 30 mm wide and 150 mm long SUS plate, crimped with one round of pressure by a 2 kg roller, to prepare a measurement sample. The measurement sample was stored in an environment 50% RH at 23° C. for 24 hours. Next, using a tensile testing machine (“Tensilon” manufactured by Orientec Co., Ltd.), peeling was conducted under the conditions of a peeling speed of 300 mm/min and a peeling angle of 180°. The state of the SUS plate after the peeling was observed. If a large amount of pressure sensitive adhesive adheres to the SUS surface after peeling, it is not suitable for applications that require re-peeling.

### [Evaluation Criteria]

+++: No residue of pressure sensitive adhesive observed on the measured part of the SUS surface, Excellent.

++: Residue of adhered pressure sensitive adhesive observed on the measured part of the SUS surface, but the area was 3% or less, Good.

+: Area of adhered pressure sensitive adhesive on the measured part of the SUS surface exceeds 3% but was less than 10%, Practically usable.

NG: Area of adhered pressure sensitive adhesive on the measured part of the SUS surface was 10% or more, Not usable.

### (Storage Stability)

The pressure sensitive adhesive, uniformly mixed after blending a curing agent, was placed under the atmosphere of −50% RH at 23° C. The viscosity increase rate was calculated using the following Expression (15):

$$( Viscosity increase rate ) = \{ ( viscosity 1 week after blending the curing agent ) / ( viscosity 1 hour after blending the curing agent ) \times 100 \} \qquad ( 15 )$$

### [Evaluation Criteria]

+++: Viscosity increase rate was less than 150%, Excellent.

++: Viscosity increase rate was 150% or more and less than 160%, Good.

+: Viscosity increase rate was 160% or more and less than 170%, Practically usable.

NG: Viscosity increase rate was 170% or more, Not usable.

### (Coating Film Appearance)

The coating film appearance of the pressure sensitive adhesive sheet after curing under an atmosphere of −50% RH at 23° C. for 1 week was visually confirmed.

### [Evaluation Criteria]

+++: Colorless, transparent, Practically usable

++: White, Practically usable for some applications

TABLE 3

| | | | | | | | | Peeled | | |
|---|---|---|---|---|---|---|---|---|---|---|
| | | Gel fraction rate | | | | | | state after | | |
| | | Degree of | | Degree of | | Gel | | measuring | | |
| | | crosslinking | | crosslinking | | fraction | | pressure | | |
| | | after | | after | | rate after 7 | Holding | sensitive | Storage | Coating film |
| | | 5 hours | Evaluation | 24 hours | Evaluation | days % | force | adhesive force | stability | appearance |
| Example | 1-1 | 93 | +++ | 96 | +++ | 60 | +++ | +++ | +++ | +++ |
| | 1-2 | 95 | +++ | 95 | +++ | 65 | +++ | +++ | +++ | +++ |
| | 1-3 | 94 | +++ | 95 | +++ | 62 | +++ | +++ | +++ | +++ |
| | 1-4 | 93 | +++ | 96 | +++ | 60 | +++ | +++ | ++ | +++ |
| | 1-5 | 91 | +++ | 92 | +++ | 52 | ++ | +++ | +++ | +++ |
| | 1-6 | 92 | +++ | 93 | +++ | 50 | +++ | +++ | +++ | +++ |
| | 1-7 | 95 | +++ | 96 | +++ | 63 | +++ | +++ | +++ | +++ |
| | 1-8 | 95 | +++ | 97 | +++ | 67 | +++ | ++ | +++ | +++ |
| | 1-9 | 92 | +++ | 95 | +++ | 45 | +++ | +++ | +++ | +++ |
| | 1-10 | 93 | +++ | 95 | +++ | 58 | +++ | +++ | +++ | +++ |
| | 1-11 | 92 | +++ | 95 | +++ | 68 | +++ | +++ | +++ | +++ |
| | 1-12 | 92 | +++ | 95 | +++ | 55 | +++ | +++ | +++ | +++ |
| | 1-13 | 89 | +++ | 94 | +++ | 58 | +++ | +++ | +++ | +++ |
| | 1-14 | 94 | +++ | 95 | +++ | 55 | +++ | +++ | +++ | +++ |
| | 1-15 | 94 | +++ | 94 | +++ | 51 | +++ | +++ | +++ | +++ |
| | 1-16 | 73 | ++ | 90 | +++ | 58 | +++ | +++ | +++ | +++ |
| | 1-17 | 63 | ++ | 88 | +++ | 55 | +++ | +++ | +++ | +++ |
| | 1-18 | 93 | +++ | 96 | +++ | 45 | +++ | +++ | +++ | +++ |
| | 1-19 | 58 | ++ | 79 | ++ | 55 | +++ | +++ | +++ | +++ |
| | 1-20 | 89 | +++ | 91 | +++ | 44 | ++ | +++ | +++ | ++ |
| | 1-21 | 89 | +++ | 89 | +++ | 41 | ++ | +++ | +++ | ++ |
| | 1-22 | 49 | + | 90 | +++ | 58 | +++ | +++ | +++ | +++ |
| | 1-23 | 48 | + | 91 | +++ | 57 | +++ | +++ | +++ | +++ |
| | 1-24 | 45 | + | 75 | ++ | 58 | +++ | +++ | +++ | +++ |
| | 1-25 | 42 | + | 68 | ++ | 56 | +++ | +++ | +++ | +++ |
| | 1-26 | 15 | + | 62 | ++ | 54 | +++ | +++ | +++ | +++ |
| | 1-27 | 12 | + | 49 | + | 53 | +++ | +++ | +++ | +++ |
| | 1-28 | 10 | + | 15 | + | 10 | + | +++ | +++ | +++ |
| | 1-29 | 10 | + | 51 | ++ | 51 | ++ | +++ | +++ | +++ |
| | 1-30 | 40 | + | 68 | ++ | 58 | +++ | +++ | +++ | +++ |
| | 1-31 | 42 | + | 70 | ++ | 60 | +++ | +++ | +++ | +++ |
| | 1-32 | 44 | + | 72 | ++ | 65 | +++ | ++ | +++ | +++ |
| | 1-33 | 44 | + | 73 | ++ | 66 | +++ | + | +++ | +++ |
| Comparative | 1-1 | 0 | NG | 0 | NG | 57 | +++ | +++ | +++ | +++ |
| Example | 1-2 | 0 | NG | 0 | NG | 0 | NG | NG | +++ | +++ |
| | 1-3 | 0 | NG | 0 | NG | 58 | +++ | +++ | +++ | +++ |
| | 1-4 | 0 | NG | 21 | NG | 55 | +++ | +++ | NG | +++ |

It was possible to produce the pressure sensitive adhesive that includes the acrylic polymer (A), the metal chelate compound (B), and the polycarboxylic acid compound (C) according to the first embodiment, in which the acrylic polymer (A) is composed of the monomer mixture containing an acidic group-containing monomer (a1), the acidic group-containing monomer (a1) is 0.01 to 20 mass % per 100 mass % of the monomer component, the pressure sensitive adhesive has a satisfactory degree of crosslinking after 5 hours or 24 hours of curing, is a pressure sensitive adhesive that can be made ageless, and the pressure sensitive adhesive sheet has a satisfactory holding force and transparency.

### <Production of Acrylic Polymer>

### (Acrylic Polymer (2 A-1))

In a reaction vessel including a stirrer, a thermometer, a reflux cooling tube, a dropping funnel, and a nitrogen introduction tube (hereinafter referred to simply as “reaction vessel”), 45 parts of butyl acrylate, 40 parts of 2-ethylhexyl acrylate, 10 parts of methyl acrylate, 5 parts of acrylic acid, 1 part of 2-hydroxyethyl acrylate, 115 parts of ethyl acetate, and 0.02 parts of 2,2′-azobisisobutyronitrile (AIBN) were charged. After the charging, the air inside the reaction vessel was replaced with nitrogen gas. Furthermore, 45 parts of butyl acrylate, 40 parts of 2-ethylhexyl acrylate, 10 parts of methyl acrylate, 5 parts of acrylic acid, 115 parts of ethyl acetate, and 0.02 parts of 2,2′-azobisisobutyronitrile (AIBN) were charged into a dropping funnel. Next, the reaction vessel was heated to 80° C. under a nitrogen atmosphere with stirring, and after initiating the reaction, the content of the dropping funnel was added dropwise over 2 hours, and polymerization reaction was carried out for 8 hours at a reflux temperature under a nitrogen atmosphere. After the completion of the reaction, the mixture was cooled, and diluted with isopropyl alcohol, and a 35% non-volatile acrylic polymer (2A-1) solution was obtained. The weight-average molecular weight (Mw) of the acrylic polymer (2A-1) was 790,000.

### (Acrylic Polymer (2A-2 to 2A-9)

Each of the acrylic polymers (2A-2 to 2A-9, 2A′-1, 2A′-2) was synthesized in the same manner as the acrylic polymer (A-1), except that the compositions and the blending amounts (in parts by mass) shown in Table 4 were changed.

TABLE 4

| | | | | | | | | | Weight- |
|---|---|---|---|---|---|---|---|---|---|
| | Acrylic copolymer | | | | | | | | average |
| | Monomer | | Monomer | Other | | Monomer | | (a1) | molecular |
| Acrylic | (a2y) | | (a2x) | monomers | | (a1) | | Content | weight (Mw) |
| polymer | BA | 2EHA | MA | MAH | HEA | AA | β-CEA | [%] | [10,000] |
| (2A-1) | 45 | 40 | 10 | | | 5 | | 5 | 79 |
| (2A-2) | 45 | 40 | 10 | | | | 5 | 5 | 78 |
| (2A-3) | 45 | 40 | 8 | 2 | | 5 | | 5 | 77 |
| (2A-4) | 45 | 40 | 5 | 5 | | 5 | | 5 | 72 |
| (2A-5) | 45 | 44.97 | 10 | | | 0.03 | | 0.03 | 75 |
| (2A-6) | 45 | 44 | 10 | | | 1 | | 1 | 76 |
| (2A-7) | 45 | 42.5 | 10 | | | 2.5 | | 2.5 | 76 |
| (2A-8) | 45 | 40 | 5 | | | 10 | | 10 | 77 |
| (2A-9) | 44 | 40 | | | | 16 | | 16 | 76 |
| (2A′-1) | 45 | 43 | 10 | | 2 | | | 0 | 76 |
| (2A′-2) | 30 | 40 | 5 | | | 25 | | 25 | 75 |

### Example 2-1

### <Production of Pressure Sensitive Adhesive Composition>

For 100 parts of an acrylic polymer (2A-1), 0.8 parts of AL-A (Aluminum chelate A, aluminum tris (acetylacetonate), manufactured by Kawaken Fine Chemical Co., Ltd.) as the metal chelate compound (B), 0.3 parts of maleic acid as the polycarboxylic acid compound (C), and 1.0 parts of acetylacetone as the catalyst action inhibitor (b1) were blended on a non-volatile basis, and ethyl acetate was incorporated as a solvent so that the non-volatile content was 30%, and the mixture was thoroughly mixed to obtain the pressure sensitive adhesive composition.

### <Production of Pressure Sensitive Adhesive Sheet>

The obtained pressure sensitive adhesive composition was coated so that the thickness after drying was 25 μm on a release-treated surface of a releasable sheet (made of polyethylene terephthalate, hereinafter referred to as “releasable film substrate”) having a thickness of 38 μm, and dried in a hot air oven at 100° C. for 90 seconds to create a pressure sensitive adhesive layer. After drying, the pressure sensitive adhesive layer was laminated on a substrate (made of polyethylene terephthalate) having a thickness of 50 μm, and further cured at 23° C. and −50% RH for 7 days to obtain a pressure sensitive adhesive sheet.

### Example 2-2 to 2-27, Comparative Example 2-1 to 2-7

Each of the pressure sensitive adhesive composition and pressure sensitive adhesive sheet was produced in the same manner as the pressure sensitive adhesive sheet of Example 2-1, except that the compositions and the blending amounts (in parts by mass) shown in Table 5 were changed. When a polycarboxylic acid compound or its anhydride was used as the monomer component, the content of the polycarboxylic acid compound (C) in the pressure sensitive adhesive composition was calculated by gas chromatography analysis.

TABLE 5

| | | | Curing agent | | | | | | | | | | | Polycarboxylic | Catalyst |
|---|---|---|---|---|---|---|---|---|---|---|---|---|---|---|---|
| | | | | | Other | | | | | | | | | acid | action |
| | | | Metal chelate | | curing | | | | | | | | | compound | inhibitor |
| | | Acrylic | compound (B) | | agent | | Polycarboxylic acid compound (C) | | | | | | | (C) | (b1) |
| | | polymer | AL-A | AL-D | TDI-TMP | Water | MAC | PHA | FMA | SCA | MLA | TMA | CTA | Content | AcAc |
| Example | 2-1 | 2A-1 | 0.8 | | | | 0.3 | | | | | | | 0.3 | 1 |
| | 2-2 | 2A-2 | 0.3 | | | | 0.3 | | | | | | | 0.3 | 1 |
| | 2-3 | 2A-3 | 1 | | | | 0.15 | | | | | | | 0.15 | 1 |
| | 2-4 | 2A-1 | 0.8 | | | | | 0.3 | | | | | | 0.3 | 1 |
| | 2-5 | 2A-1 | 0.8 | | | | | | 0.3 | | | | | 0.3 | 1 |
| | 2-6 | 2A-1 | 0.8 | | | | | | | 0.3 | | | | 0.3 | 1 |
| | 2-7 | 2A-1 | 0.8 | | | | | | | | 0.3 | | | 0.3 | 1 |
| | 2-8 | 2A-1 | 0.8 | | | | | | | | | 0.3 | | 0.3 | 1 |
| | 2-9 | 2A-1 | | 0.8 | | | 0.3 | | | | | | | 0.3 | 1 |
| | 2-10 | 2A-2 | 0.8 | | | | 0.3 | | | | | | | 0.2 | 1 |
| | 2-11 | 2A-3 | 0.8 | | | 5 | | | | | | | | 0.2 | 1 |
| | 2-12 | 2A-4 | 0.8 | | | 5 | | | | | | | | 0.5 | 1 |
| | 2-13 | 2A-1 | 0.8 | | | | 0.02 | | | | | | | 0.02 | 1 |
| | 2-14 | 2A-1 | 0.8 | | | | 0.05 | | | | | | | 0.05 | 1 |
| | 2-15 | 2A-1 | 0.8 | | | | 0.1 | | | | | | | 0.1 | 1 |
| | 2-16 | 2A-1 | 0.8 | | | | 0.8 | | | | | | | 0.8 | 1 |
| | 2-17 | 2A-1 | 0.8 | | | | 1.2 | | | | | | | 1.2 | 1 |
| | 2-18 | 2A-1 | 0.8 | | | | 1.5 | | | | | | | 1.5 | 1 |
| | 2-19 | 2A-1 | 0.8 | | | | 2.5 | | | | | | | 2.5 | 1 |
| | 2-20 | 2A-1 | 0.1 | | | | 0.3 | | | | | | | 0.3 | 1 |
| | 2-21 | 2A-1 | 2 | | | | 0.3 | | | | | | | 0.3 | 1 |
| | 2-22 | 2A-5 | 2 | | | | 0.3 | | | | | | | 0.3 | 1 |
| | 2-23 | 2A-6 | 0.8 | | | | 0.3 | | | | | | | 0.3 | 1 |
| | 2-24 | 2A-7 | 0.8 | | | | 0.3 | | | | | | | 0.3 | 1 |
| | 2-25 | 2A-8 | 0.6 | | | | 0.3 | | | | | | | 0.3 | 1 |
| | 2-26 | 2A-9 | 0.5 | | | | 0.3 | | | | | | | 0.3 | 1 |
| | 2-27 | 2A-6 | 2.5 | | | | | | | | | | | 0 | 1 |
| Comparative | 2-1 | 2A-1 | 0.8 | | | | | | | | | | | 0 | 1 |
| Example | 2-2 | 2A′-1 | 0.8 | | | | | | | | | | | 0 | 1 |
| | 2-3 | 2A′-1 | 0.8 | | | | | | | | | | | 0 | 1 |
| | 2-4 | 2A-1 | 0.8 | | | | | | | | | | 4 | 4 | 1 |
| | 2-5 | 2A-1 | 0.8 | | | | 15 | | | | | | | 15 | 1 |
| | 2-6 | 2A-2 | | | 5 | | | | | | | | | 0 | 0 |
| | 2-7 | 2A′-1 | 0.8 | | | | 0.3 | | | | | | | 0.3 | 1 |

TABLE 6

| | | | | | | | Pressure | | | Pressure | | | |
|---|---|---|---|---|---|---|---|---|---|---|---|---|---|
| | | Gel fraction rate | | | Pocessability | | sensitive | | | sensitive | | | |
| | | Ethyl | | | 5 hours | 7 days | adhesive | Peeled | Holding | adhesive force | Peeled | Coating | |
| | | acetate | Toluene | | after | after | force | state | force | over time | state | film | Storage |
| | | [%] | [%] | P | coating | coating | 5 hours after coating | | | 7 days after coating | | appearance | stability |
| Example | 2-1 | 55 | 45 | 0.82 | +++ | +++ | +++ | +++ | +++ | +++ | +++ | +++ | +++ |
| | 2-2 | 28 | 20 | 0.71 | ++ | +++ | +++ | +++ | +++ | +++ | +++ | +++ | +++ |
| | 2-3 | 84 | 80 | 0.95 | +++ | +++ | ++ | +++ | +++ | +++ | +++ | +++ | +++ |
| | 2-4 | 52 | 40 | 0.77 | +++ | +++ | +++ | +++ | +++ | +++ | +++ | +++ | +++ |
| | 2-5 | 52 | 39 | 0.75 | +++ | +++ | +++ | +++ | +++ | +++ | +++ | +++ | +++ |
| | 2-6 | 53 | 39 | 0.74 | +++ | +++ | +++ | +++ | +++ | +++ | +++ | +++ | +++ |
| | 2-7 | 51 | 36 | 0.71 | +++ | +++ | +++ | +++ | +++ | +++ | +++ | +++ | +++ |
| | 2-8 | 50 | 15 | 0.30 | ++ | ++ | +++ | +++ | +++ | +++ | +++ | +++ | +++ |
| | 2-9 | 56 | 46 | 0.82 | +++ | +++ | +++ | +++ | +++ | +++ | +++ | +++ | +++ |
| | 2-10 | 52 | 41 | 0.79 | +++ | +++ | +++ | +++ | +++ | +++ | +++ | +++ | +++ |
| | 2-11 | 56 | 44 | 0.79 | +++ | +++ | +++ | +++ | +++ | +++ | +++ | +++ | +++ |
| | 2-12 | 55 | 47 | 0.85 | +++ | +++ | +++ | +++ | +++ | +++ | +++ | +++ | +++ |
| | 2-13 | 54 | 12 | 0.22 | + | ++ | +++ | +++ | ++ | +++ | +++ | +++ | +++ |
| | 2-14 | 56 | 18 | 0.32 | ++ | ++ | +++ | +++ | +++ | +++ | +++ | +++ | +++ |
| | 2-15 | 55 | 42 | 0.76 | +++ | +++ | +++ | +++ | +++ | +++ | +++ | +++ | +++ |
| | 2-16 | 50 | 41 | 0.82 | +++ | +++ | +++ | +++ | +++ | +++ | +++ | +++ | +++ |
| | 2-17 | 50 | 41 | 0.82 | +++ | +++ | +++ | +++ | +++ | +++ | +++ | +++ | +++ |
| | 2-18 | 55 | 54 | 0.98 | ++ | +++ | +++ | +++ | ++ | +++ | +++ | ++ | +++ |
| | 2-19 | 58 | 58 | 1.00 | +++ | +++ | ++ | +++ | ++ | +++ | +++ | ++ | +++ |
| | 2-20 | 8 | 2 | 0.25 | + | + | +++ | + | + | +++ | + | +++ | +++ |
| | 2-21 | 97 | 96 | 0.99 | +++ | +++ | + | ++ | +++ | ++ | + | +++ | +++ |
| | 2-22 | 33 | 7 | 0.21 | ++ | ++ | +++ | ++ | ++ | ++ | +++ | +++ | +++ |
| | 2-23 | 40 | 25 | 0.63 | +++ | +++ | +++ | +++ | +++ | +++ | +++ | +++ | +++ |
| | 2-24 | 38 | 28 | 0.74 | +++ | +++ | +++ | +++ | +++ | +++ | +++ | +++ | +++ |
| | 2-25 | 60 | 47 | 0.78 | +++ | +++ | +++ | +++ | +++ | +++ | +++ | +++ | +++ |
| | 2-26 | 67 | 50 | 0.75 | +++ | +++ | +++ | +++ | +++ | +++ | ++ | +++ | +++ |
| | 2-27 | 98 | 20 | 0.20 | + | +++ | +++ | + | + | + | ++ | +++ | ++ |
| Comparative | 2-1 | 55 | 2 | 0.04 | NG | ++ | +++ | + | NG | +++ | +++ | +++ | +++ |
| Example | 2-2 | 2 | 0 | 0.00 | NG | NG | +++ | + | NG | +++ | + | +++ | +++ |
| | 2-3 | 75 | 10 | 0.13 | NG | ++ | +++ | + | NG | + | + | +++ | +++ |
| | 2-4 | 55 | 6 | 0.11 | NG | NG | +++ | + | NG | +++ | +++ | +++ | +++ |
| | 2-5 | 42 | 5 | 0.12 | NG | ++ | +++ | + | NG | +++ | +++ | NG | +++ |
| | 2-6 | 50 | 50 | 1.00 | NG | ++ | ++ | + | NG | NG | +++ | +++ | NG |
| | 2-7 | 4 | 0 | 0.00 | NG | NG | +++ | + | NG | +++ | + | +++ | +++ |

### [Evaluation Items and Evaluation Methods]

The pressure sensitive adhesive composition and pressure sensitive adhesive sheet obtained were evaluated in the following manner.

### (Gel Fraction Rate)

After coating the substrate, specimens 30 mm in width and 100 mm in length were cut from the pressure sensitive adhesive sheet cured under an atmosphere of −50% RH at 23° C. for 7 days, and the weight of the specimens was measured. The release sheet was peeled off from the specimen, the exposed pressure sensitive adhesive layer was attached to a stainless steel wire mesh with a mesh count of 300. The wire mesh was folded to prevent the specimen from peeling, the specimen was immersed in ethyl acetate or toluene as an extraction solution with the specimen wrapped with the wire mesh, and the specimen was left at 50° C. for 24 hours. After the immersion, the wire mesh was removed, washed with a small amount of ethyl acetate or toluene, dried at 100° C. for 30 minutes, and measured the weight. The gel fraction rate was calculated by the following Expression (22):

$$( G el fraction rate ) = \{ ( W 2 - W 0 - W 3 ) / ( W 1 - W 0 - W 3 ) \} \times 100 \\ W 0 : Weight of wire mesh \\ W 1 : Weight of wire mesh + specimen \\ W 2 : Weight of wire mesh + specimen after drying \\ W 3 : Weight of the substrate of the specimen \qquad ( 22 )$$

### <Gel Fraction Rate of Toluene and Ethyl Acetate (P)>

The gel fraction rate of toluene and ethyl acetate (P) was calculated by the following Expression (21) based on the gel fraction of each extraction solution calculated by the Expression (22).

(P)=(gel fraction rate (Y) when toluene was used as extraction solution)/(gel fraction rate (X) when ethyl acetate was used as extraction solution) (21)

### (Processability)

A pressure sensitive adhesive sheet after curing under an atmosphere of −50% RH at 23° C. RH for 5 hours or 7 days was prepared with a width of 10 mm and a length of 10 mm. The releasable sheet was peeled off from the pressure sensitive adhesive sheet, and the pressure sensitive adhesive sheet was sandwiched from the top and bottom by the releasable sheet (made of polyethylene terephthalate) with a thickness of 38 μm, and the sheets were left for 2 hours under an environment of 40° C. with a pressure of 50 Kg/cm² using a press tester. After the test, the sample was taken out, and the width of the glue protruding from the end of the specimen was measured (maximum value).

### Evaluation Criteria

+++: Protrusion is less than 0.2 mm, Excellent.

++: Protrusion is 0.2 mm or more and less than 0.4 mm, Good.

+: Protrusion is 0.4 mm or more and less than 0.6 mm, Practically usable.

NG: Protrusion is 0.6 mm or more, Not practically usable.

### (Pressure Sensitive Adhesive Force)

Specimens of 25 mm in width and 150 mm in length were cut from a pressure sensitive adhesive sheet after 5 hours of curing under an atmosphere of −50% RH at 23° C. The exposed pressure sensitive adhesive layer, obtained by peeling off the releasable sheet from the cut pressure sensitive adhesive sheet, was attached to a surface of a stainless steel plate (SUS 304), and then crimped with one round of pressure by a 2 kg roller. After that, the specimen was left under an atmosphere of −50% RH at 23° C. for 24 hours. Next, the pressure sensitive adhesive force (pressure sensitive adhesive force before heating) was measured using a tensile testing machine (Tensilon, manufactured by Orientec Co., Ltd.) in accordance with JISZ0237 under the condition of a peeling speed of 300 mm/min and a peeling angle of 180°. The evaluation criteria were as follows.

### [Evaluation Criteria]

+++: 12 N/25 mm or more, Excellent.

++: 8 N/25 mm or more and less than 12 N/25 mm, Good.

+: 4 N/25 mm or more and less than 8 N/25 mm, Practically usable.

NG: 4 N/less than 25 mm, Not practically usable.

### (Peeled State)

The peeling behavior during the above measurement of the pressure sensitive adhesive force was observed.

### [Evaluation Criteria]

+++: Peeled at interface, Excellent.

++: Peeled at interface, zipping generated, Good.

+: Pressure sensitive adhesive residue on the stainless steel plate, Practically usable for some applications.

### (Holding Force)

Specimens of 25 mm in width and 150 mm in length were cut from a pressure sensitive adhesive sheet after 5 hours of curing under an atmosphere of −50% RH at 23° C. The exposed pressure sensitive adhesive layer, obtained by peeling off the releasable sheet from the cut pressure sensitive adhesive sheet, was attached to a 30 mm wide and 150 mm long SUS plate at the lower end part with a 25 mm wide and 25 mm long. After the pressure sensitive adhesive layer was crimped with one round of pressure by a 2 kg roller, a 1 kg weight was placed on the lower end part of the pressure sensitive adhesive sheet at an atmosphere of 70° C., and the SUS plate was left undisturbed for 70,000 seconds to measure the holding force. The evaluation involved measuring the length by which the upper end of the attached surface of the pressure sensitive adhesive sheet had shifted downward from its original position. The evaluation criteria were as follows:

### [Evaluation Criteria]

+++: Shift length was less than 0.5 mm, Excellent.

++: Shift length was 0.5 mm or more and 5 mm or less, Good.

+: Shift length was 5 mm or more and less than 25 mm, Practically usable.

NG: Shift length was 25 mm or more, and it fell within 70,000 seconds, Not usable.

### (Pressure Sensitive Adhesive Force Over Time)

Specimens of 25 mm in width and 150 mm in length were cut from a pressure sensitive adhesive sheet after 7 days of curing under an atmosphere of −50% RH at 23° C. The exposed pressure sensitive adhesive layer, obtained by peeling off the releasable sheet from the cut pressure sensitive adhesive sheet, was attached to a surface of a stainless steel plate (SUS 304), and then crimped with one round of pressure by a 2 kg roller. After that, the specimen was left under an atmosphere of −50% RH at 23° C. for 24 hours. Next, the pressure sensitive adhesive force (pressure sensitive adhesive force before heating) was measured using a tensile testing machine (Tensilon, manufactured by Orientec Co., Ltd.) in accordance with JISZ0237 under the condition of a peeling speed of 300 mm/min and a peeling angle of 180°. The rate of change of the pressure sensitive adhesive force from the pressure sensitive adhesive force after 5 hours of coating was checked by the following Expression (23).

$$( Rate of change ) = ( pressure sensitive adhesive force after 7 days of coating ) / ( pressure sensitive adhesive force after 5 hours of coating ) \times 100 \qquad ( 23 )$$

The evaluation criteria were as follows.

### [Evaluation Criteria]

+++: Absolute rate of change is less than 15%, Excellent.

++: Absolute rate of change 15% or more and less than 25%, Good.

+: Absolute rate of change 25% or more and less than 35%, Practically usable.

NG: Absolute rate of change 35% or less, Not practically usable.

### (Peeled State)

The peeling behavior during the above measurement of the pressure sensitive adhesive force over time was observed.

### [Evaluation Criteria]

+++: Peeled at interface, Excellent.

++: Peeled at interface, zipping generated, Good.

+: Pressure sensitive adhesive residue on the stainless steel plate, Practically usable for some applications.

### (Coating Film Appearance)

The coating film appearance was checked by measuring the HAZE value of the pressure sensitive adhesive sheet after curing under an atmosphere of −50% RH at 23° C. for 7 days using NDH8000 (manufactured by Nihon Denshoku Kogyo Co., Ltd.).

### [Evaluation Criteria]

+++: HAZE value less than 10, Practically usable

++: HAZE value 10 or more and less than 20, Practically usable for some applications

NG: HAZE value 20 or more, Not usable.

### (Storage Stability)

After blending the curing agent, and uniformly mixing the pressure sensitive adhesive composition, the mixture was allowed to stand under an atmosphere of −50% RH at 23° C., and the increase rate of the viscosity was calculated using the following Expression (24).

$$( Viscosity increase rate ) = \{ ( viscosity after 7 days of blending the curing agent ) / ( viscosity after 1 hour of blending the curing agent ) \times 100 \} \qquad ( 24 )$$

### [Evaluation Criteria]

+++: Increase rate of viscosity less than 150%, Excellent.

++: Increase rate of viscosity 150% or more and less than 160%, Good.

+: Increase rate of viscosity 160% or more and less than 170%, Practically usable.

NG: Increase rate of viscosity 170% or more, Not usable.

It was possible to produce the pressure sensitive adhesive composition according to the second embodiment that includes the acrylic polymer (A) and the metal chelate compound (B), in which the acrylic polymer (A) is a copolymer of a monomer mixture including the monomer (a1) with the acidic group, the content of the monomer (a1) with the acidic group is 0.01 mass % or more and 20 mass % or less in 100 mass % of the monomer mixture, and the gel fraction rate (P) of toluene and ethyl acetate represented by Expression (21) is 0.2 or more, has good pressure sensitive adhesive properties after 5 hours of curing, and the difference between the performance of the pressure sensitive adhesive composition after 5 hours of curing and the performance of the pressure sensitive adhesive composition after 7 days of curing is small, and the pressure sensitive adhesive sheet has transparency and storage stability.

### [Supplementary Notes]

The present specification also discloses an invention embodying the technological concepts as understood from the above embodiments.

(Supplementary note 1): A pressure sensitive adhesive composition comprising:
an acrylic polymer (A);
a metal chelate compound (B); and
a polycarboxylic acid compound (C), wherein
the acrylic polymer (A) is a copolymer of a monomer mixture including a monomer (a1) having an acidic group, and
a content of the monomer (a1) having the acidic group is 0.01 mass % or more and 20 mass % or less per 100 mass % of the monomer mixture.

(Supplementary note 2): The pressure sensitive adhesive composition according to supplementary note 1, wherein the polycarboxylic acid compound (C) is a dicarboxylic acid compound.

(Supplementary note 3): The pressure sensitive adhesive composition according to supplementary note 1 or 2, wherein at least one of pKa values of the polycarboxylic acid compound (C) in water is in the range of 1.0 to 3.5.

(Supplementary note 4): The pressure sensitive adhesive composition according to any one of supplementary notes 1 to 3, wherein a content of the polycarboxylic acid compound (C) is 0.10 to 2.0 parts by mass per 100 parts by mass of the acrylic polymer (A).

(Supplementary note 5): A pressure sensitive adhesive composition comprising:
an acrylic polymer (A); and
a metal chelate compound (B); wherein
the acrylic polymer (A) is a copolymer of a monomer mixture including a monomer (a1) having an acidic group,
a content of the monomer (a1) having the acidic group is 0.01 mass % or more and 20 mass % or less per 100 mass % of the monomer mixture, and
a value of a gel fraction rate (P) of toluene and ethyl acetate represented by Expression (21) is 0.2 or more.

(P)=(Gel fraction rate (Y) when toluene is used as an extraction solution)/(gel fraction rate (X) when ethyl acetate is used as an extraction solution) (21)

(Supplementary note 6): The pressure sensitive adhesive composition according to supplementary note 5, wherein the gel fraction rate (X) when ethyl acetate is used as the extraction solution is 10% or more and 95% or less.

(Supplementary note 7): The pressure sensitive adhesive composition according to supplementary note 5 or 6, wherein the value of the gel fraction rate (P) of toluene and ethyl acetate is 0.3 or more and 0.98 or less.

(Supplementary note 8): A pressure sensitive adhesive sheet comprising:
a substrate; and
a pressure sensitive adhesive layer formed from the pressure sensitive adhesive composition according to any one of supplementary notes 1 to 7.

This application claims the priority based on Japanese Patent Application No. 2021-150215 filed Sep. 15, 2021 and Japanese Patent Application No. 2022-39823 filed Mar. 15, 2022 disclosure of which is incorporated by reference in its entirety.

1-6. (canceled)

7. A pressure sensitive adhesive composition comprising:
an acrylic polymer (A);
a metal chelate compound (B); and
a polycarboxylic acid compound (C), wherein
the acrylic polymer (A) is a copolymer of a monomer mixture including a monomer (a1) having an acidic group,
a content of the monomer (a1) having the acidic group is 0.01 mass % or more and 20 mass % or less per 100 mass % of the monomer mixture,
the polycarboxylic acid compound (C) includes at least one kind selected from a group consisting of saturated dicarboxylic acids, unsaturated dicarboxylic acids, aromatic-containing polycarboxylic acids, and aliphatic cyclic structure-containing polycarboxylic acids,
a content of the polycarboxylic acid compound (C) is 0.010 parts by mass or more and 9.0 parts by mass or less per 100 parts by mass of the acrylic polymer (A), and
a value of a gel fraction rate (P) of toluene and ethyl acetate represented by:
(P)=(Gel fraction rate (Y) when toluene is used as an extraction solution)/(gel fraction rate (X) when ethyl acetate is used as an extraction solution)
is 0.2 or more.

8. The pressure sensitive adhesive composition according to claim 7, wherein the gel fraction rate (X) when ethyl acetate is used as the extraction solution is 10% or more and 95% or less.

9. The pressure sensitive adhesive composition according to claim 7, wherein the value of the gel fraction rate (P) of toluene and ethyl acetate is 0.3 or more and 0.98 or less.

10. A pressure sensitive adhesive sheet comprising:
a substrate; and
a pressure sensitive adhesive layer formed from the pressure sensitive adhesive composition according to claim 7.
